(19) United States
(12) Patent Application Publication
(10) Pub. No.: US 2009/0138316 A1
(43) Pub. Date: May 28, 2009

(54) SYSTEM AND METHOD FOR EVALUATING INITIATIVES ADAPTED TO DELIVER VALUE TO A CUSTOMER

(75) Inventors: Andrew Weller, Ocean Grove (AU); James Anthony Delany, Metung (AU)

Correspondence Address: SEED INTELLECTUAL PROPERTY LAW GROUP PLLC, 701 FIFTH AVE, SUITE 5400, SEATTLE, WA, 98104, US

(73) Assignee: BP AUSTRALIA PTY LTD, Melbourne (AU)

(21) Appl. No.: 11/815,557

(22) PCT Filed: Feb. 3, 2006
(86) PCT No.: PCT/AU2006/000137

§ 371 Date: Jan. 27, 2009

(30) Foreign Application Priority Data
Feb. 4, 2005 (AU) 2005900514

(51) Int. Cl. G06Q 10/00

(52) U.S. Cl. 705/9; 705/10

(57) ABSTRACT

A value data system, including a database component, including: initiative data representing at least one initiative, said at least one initiative being adapted to deliver value to a customer of an organisation; risk data associated with said initiative data, said risk data representing risks corresponding to said at least one initiative; task data associated with said initiative data, said task data representing tasks to be performed to perform said at least one initiative, said tasks including risk mitigation tasks for mitigating said risks; and value data associated with said initiative data, said value data representing values delivered to said customer as a result of performing said at least one initiative; and a user interface component for defining said initiative data, said risk data, said task data, said value data and the associations between said initiative data, said risk data, said task data, and said value component data; and for defining value data representing values delivered to said customer as a result of performing said at least one initiative.

### FIELD OF THE INVENTION

The present invention relates to a value data system, and in particular a value data system and process for use in delivering value to customers of an organisation.

### BACKGROUND

In recent years, commercial buyers have replaced the traditional practice of purchasing stock units with the development of requests for quotations (RFQs) for public tenders. In response to an RFQ, prospective vendors are encouraged to submit product supply offers. Typically, an RFQ is reviewed by a buyer using a simple spreadsheet application to perform simple calculations and thereby evaluate the differences between vendor offers. Traditionally, the value delivered from contracts such as these has been measured on a cost per unit basis. However, as both purchaser and vendor try to leverage more value from this model, new performance measures such as “in full on time” (IFOT), commitment technical time invested in the customer, reduction in total costs, and environmental impact have been included in RFQs and also in the resulting contracts. However, such measures have been dealt with in an ad hoc manner, making it exceedingly difficult for commercial buyers to evaluate different product offers and for organisations and their customers to determine the value delivered and to manage the delivery of that value.

It is desired to provide a value data system and process that alleviate one or more of the above difficulties, or at least provide a useful alternative.

### SUMMARY OF THE INVENTION

In accordance with the present invention, there is provided a value data system, including:
a database component, including:
   initiative data representing at least one initiative, said at least one initiative being adapted to deliver value to a customer of an organisation;
   risk data associated with said initiative data, said risk data representing risks corresponding to said at least one initiative;
   task data associated with said initiative data, said task data representing tasks to be performed to perform said at least one initiative, said tasks including risk mitigation tasks for mitigating said risks; and
   value data associated with said initiative data, said value data representing values delivered to said customer as a result of performing said at least one initiative;
and
a user interface component for:
   (i) defining said initiative data, said risk data, said task data, said value data and the associations between said initiative data, said risk data, said task data, and said value component data; and
   (ii) defining value data representing values delivered to said customer as a result of performing said at least one initiative.

The present invention also provides a value data system adapted to maintain initiative data representing initiatives for delivering value to a customer of an organisation, said initiative data including state data representing a state of each initiative and value data representing value delivered to said organisation as a result of performing said initiatives.

The present invention also provides a value data process executed by a computer system, including maintaining initiative data representing initiatives for delivering value to a customer of an organisation, said initiative data including state data representing a state of each initiative, and value data representing said value as one or more key performance indicators.

### BRIEF DESCRIPTION OF THE DRAWINGS

Preferred embodiments of the present invention are hereinafter described, by way of example only, with reference to the accompanying drawings, wherein:

FIG. 1 is a schematic diagram of a preferred embodiment of a value data system;

FIG. 2 is a block diagram of management terminals and database servers of the value data system;

FIG. 3A is a screenshot showing database forms of a front end database of the value data system;

FIG. 3B is a screenshot showing database tables of a back end database of the value data system;

FIG. 4 is a schematic diagram illustrating database synchronisation between various copies of the back end database;

FIG. 5 is a flow diagram of a value data process of the system;

FIG. 6 is a flow diagram of a customer management process of the value data process;

FIG. 7 is a flow diagram of a service design process of the value data process;

FIG. 8 is a flow diagram of an opportunity management process of the value data process;

FIG. 9 is a flow diagram of a continuous improvement process of the value data process;

FIG. 10 is a screenshot of a main screen generated by the system;

FIG. 11 is a screenshot illustrating a customer selection menu of the main screen;

FIG. 12 is a screenshot illustrating a key accounts management menu of the main screen;

FIG. 13 is a screenshot of a customer management screen generated by the system;

FIG. 14 is a screenshot of a key performance indicators (KPIs) screen generated by the system;

FIGS. 15A and 15B are screenshots of corporate KPIs management screens generated by the system;

FIG. 16 is a screenshot of an Actions screen generated by the system;

FIGS. 17A and 17B are screenshots of a service design management screen and a new service screen generated by the system respectively;

FIGS. 17C and 17D are screenshots of sub report type and report type database tables of the system;

FIGS. 18A to 18H are screenshots showing various tabs of a task design screen generated by the system;

FIG. 19 is a screenshot of a skills matrix screen generated by the system;

FIG. 20 is a screenshot of a skills category management screen generated by the system;

FIG. 21 is a screenshot of an opportunity locator screen generated by the system;

FIG. 22 is a screenshot of a Plan state opportunity management screen generated by the system;

FIG. 23 is a screenshot of a Do state opportunity management screen generated by the system;

FIG. 24 is a screenshot of a milestone management tab of the opportunity management screen;

FIG. 25 is a screenshot of an opportunity milestones window generated from the milestones management tab;

FIG. 26 is a screenshot of an establish value tab of the opportunity management screen;

FIG. 27 is a screenshot of a commercial relevance window generated from the opportunity management screen;

FIG. 28 is a screenshot of a Check state opportunity management screen generated by the system;

FIG. 29 is a screenshot of an Act state opportunity management screen generated by the system;

FIG. 30 is a screenshot of the Act state opportunity management screen illustrating the association of a result with a closed opportunity;

FIG. 31 is a screenshot illustrating how the continuous improvement features of the system can be accessed from the main and opportunity management screens;

FIG. 32 is a screenshot of a continuous improvement management screen generated by the system;

FIG. 33 is a screenshot of a continuous improvement entry screen generated by the system;

FIG. 34 is a schematic diagram illustrating the progression of an opportunity, showing various status, states, and results associated with an opportunity;

FIG. 35 is a screenshot of a user notice entry window generated by the system;

FIGS. 36 and 37 illustrate a business case document generated by the system;

FIG. 38 is a schematic diagram illustrating the relationship between commercial, environmental and social values managed by the system and corresponding ledger codes and risk registers of the customer;

FIG. 39 is a screenshot of a survey management screen generated by the system; and

FIG. 40 is a screenshot of a product management screen generated by the system.

### DETAILED DESCRIPTION OF THE PREFERRED EMBODIMENTS

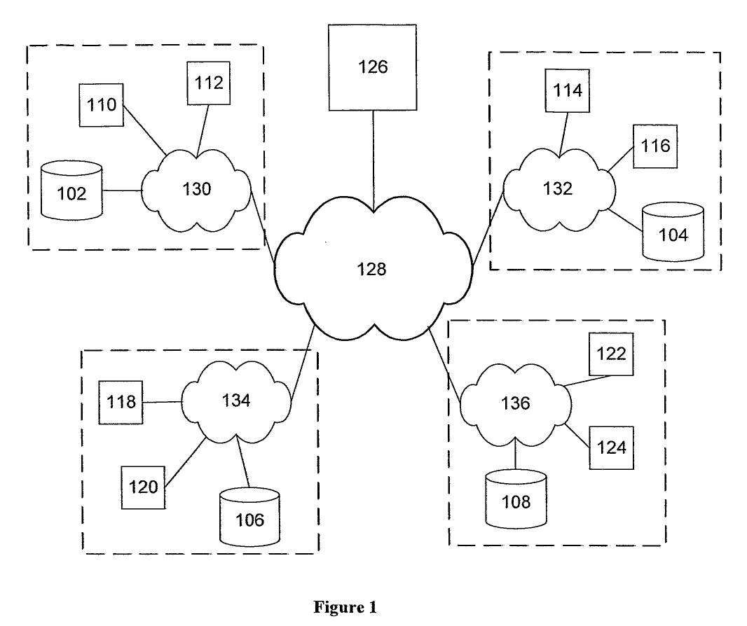

As shown in FIG. 1, a value data system includes database servers 102 to 108 and terminals 110 to 126, interconnected by a communications network 128, such as the Internet. The databases 102 to 108 and terminals 110 to 126 are geographically distributed throughout a region, which may be an entire country, and are clustered in local offices, which may be located in respective states of that country. The terminals and database server local to each state or local office are interconnected by respective local area networks 130 to 136 which themselves are interconnected via the Internet 128. When required, mobile terminals 126 can access the other components of the system at any location that provides access to the Internet 128.

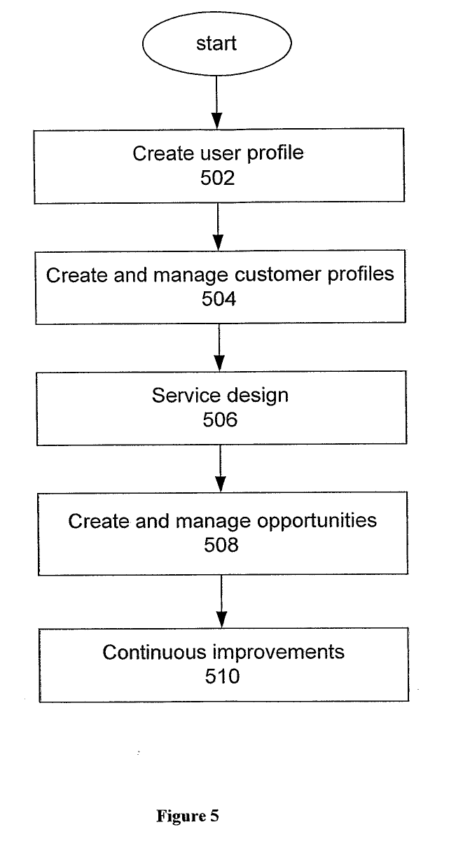

The value data system executes a value data process, as shown in FIG. 5, that ensures the delivery of value to customers of an organisation. The value that is delivered, impacting the customer's triple bottom line, includes commercial, social, and/or environmental components that can be specified in product offers or contracts between the organisation and its customers, enabling the organisation to provide additional value to its customers, thus providing a competitive advantage over the organisation's competitors. In this context, value is defined as an activity or action that affects either a general ledger code (representing commercial value), or a risk register (representing environmental value or social value). The value data system is ISO 9001:2000 certified (Quality Management System, certificate number QEC 21325) and certified to AS4360, the Australian Standard for Risk Management.

The value data system provides robust contract management and permits prioritisation of best practice processes that impact contractual obligations between the organisation and its customers. The value data system encourages the development of partnerships between the organisation and its customers, thus allowing the organisation to retain business by:
(i) Identifying and managing risk associated with activities conforming to AS4360,
(ii) Improving internal efficiency of technical and commercial resources,
(iii) Managing the commitment of technical and commercial time investments,
(iv) Capturing, recording and leveraging measurable outcomes,
(v) Reducing total costs in accordance with the ISO 9001:2000 standard, and
(vi) Delivering value to the organisation and its customers.

The value data system is initially used in contract negotiation to develop product offers and contractual obligations between the organisation and a customer. Once a contract has been agreed upon and becomes active, the value data system is then used to manage the delivery of the contracted values, as described below.

The value data system and process are described below in terms of an organisation that provides goods and/or services to its customers through two brands of petroleum products: one relating to fuels, and the other to lubricants. However, it will be apparent that the value data system and process can be used to ensure the delivery of value to customers of any kind of organisation.

In the described embodiment, the terminals 110 to 126 and database servers 102 to 108 are standard computer systems, such as Intel Architecture IA-32 computers, and the value data process is implemented as Microsoft Access database modules, as described below, stored on non-volatile (e.g., magnetic disk) storage associated with the computer systems. However, it will be apparent that at least parts of the value data process can be alternatively implemented by dedicated hardware components, such as application-specific integrated circuits (ASICs).

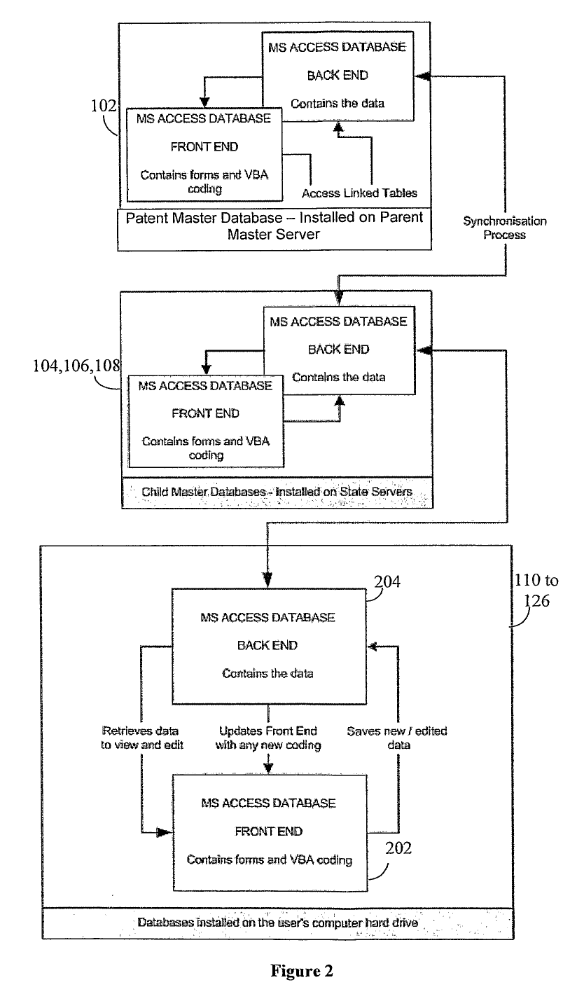

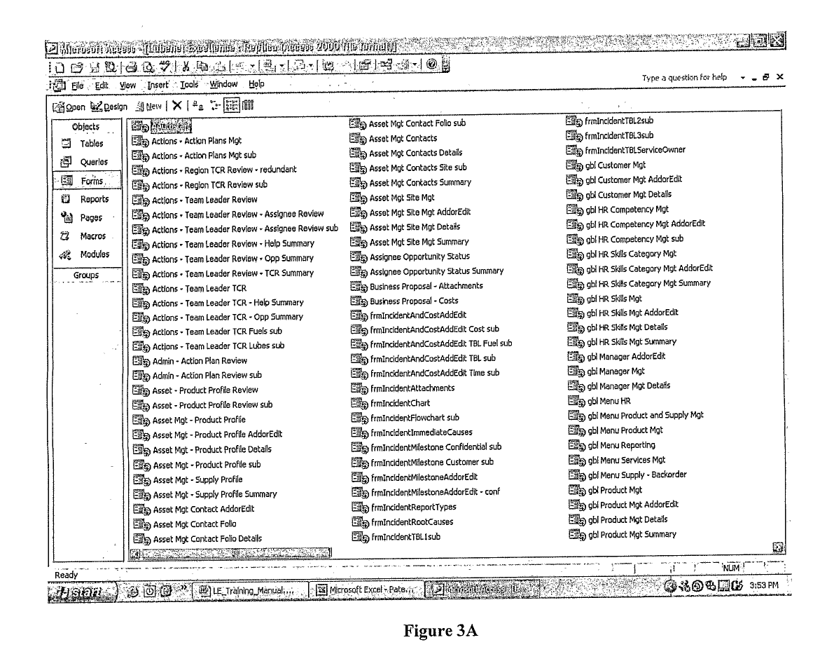

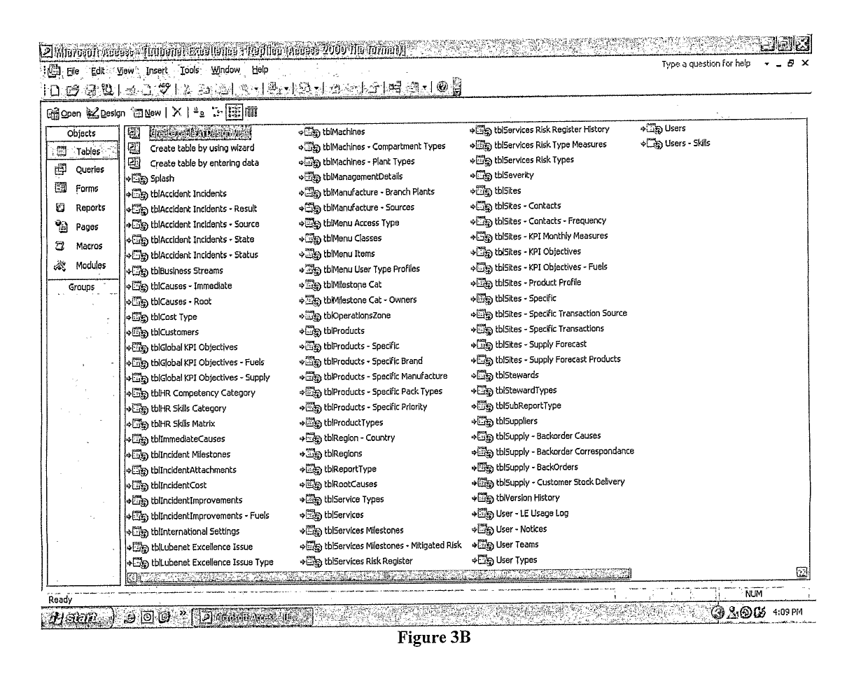

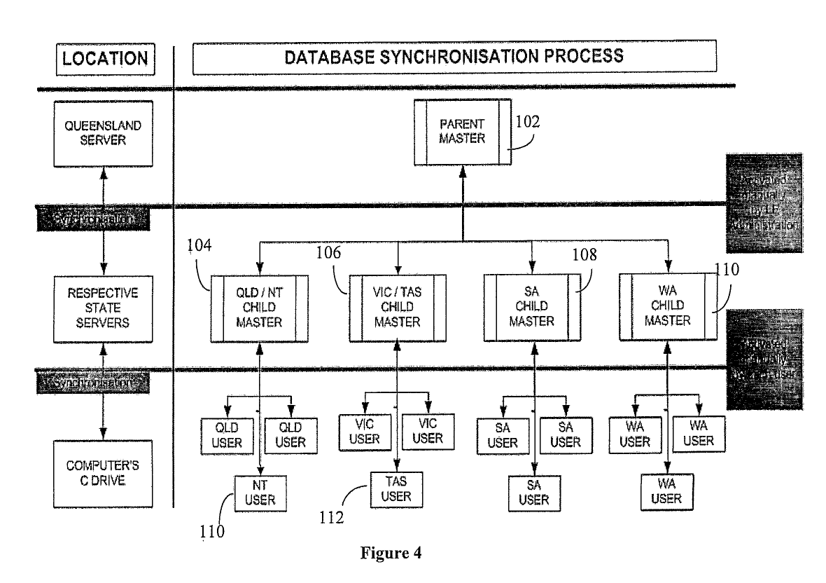

As shown in FIG. 2, each of the terminals 110 to 126 includes a front end database 202 and a back end database 204. The front end database 202 includes database forms comprising HTML and visual basic for applications (VBA) data, as shown in FIG. 3A, and the back end database 204 stores raw data in 82 database tables used by the value data system, as shown in FIG. 3B. As shown in FIG. 2, each of the local database servers 102 to 104 also includes copies of the front end database 202 and the back end database 204. One of the local database servers 102 is configured as a parent master database, while the remaining local database servers 104 to 108 are configured as child master databases. As shown in FIGS. 2 and 4, the databases 202, 204 on each management terminal 110 to 126 are synchronised with their local child master database when requested by a user, which in turn are synchronised with the global parent master database 102 in order to reduce synchronisation times for each user, and to increase the robustness of the value data system. In case of the mobile terminals 126, the synchronisation is performed when each terminal 126 is connected to the Internet 128 via a LAN or dial-up connection. Each of the terminals also includes (not shown) a Microsoft Access database application for executing the value data process.

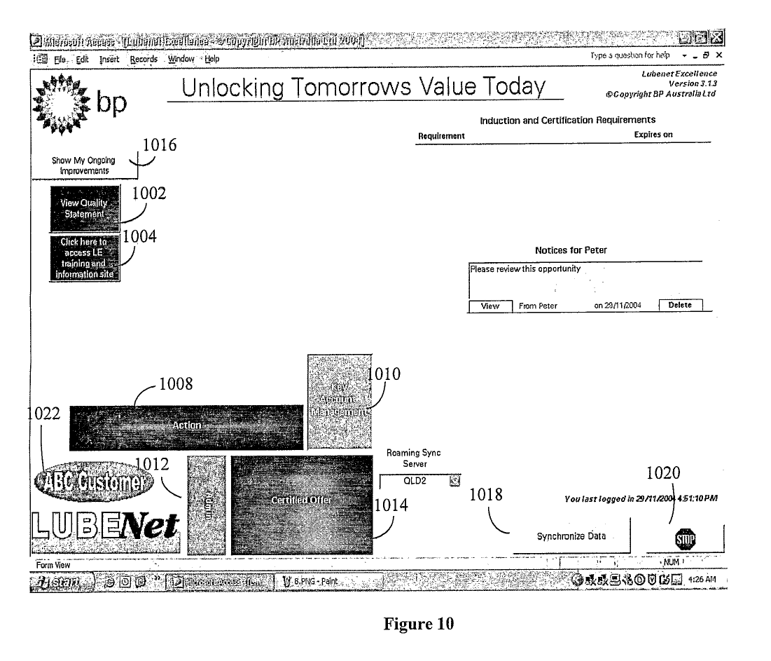

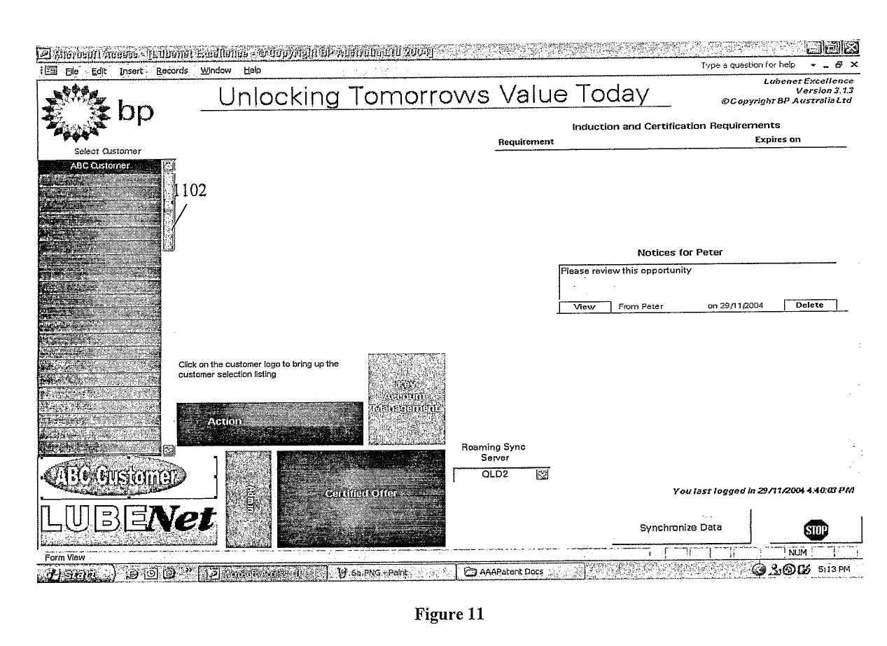

A user accesses the value data system and process by opening the local copy of the front end database 202 stored on the user's terminal. When the front end database 202 is first opened, a main screen is displayed, as shown in FIG. 10. The main screen provides a number of buttons 1002 to 1020 that are selected to access respective functions provided by the value data system. A graphic image 1022 displays the logo of the user's default customer, as specified in the user's profile. In general, the user can only access information related to one customer at a time. In order to access the data for a different customer, the user can select the displayed customer logo 1022, which causes a pop-up menu 1102 to be displayed, as shown in FIG. 11, allowing the user to select from a list of customers whose profiles have been stored in the system.

As shown in FIG. 5, the value data process begins at step 502 by creating a user profile for each user of the system. User profiles are stored in a Users table of the back end database 204. Each record of the users table stores a unique user identification number, a user name, an access level selected from one of five possible access levels, a default customer ID, the geographical region that the user is assigned to within the organisation, the team that the user is assigned to within the organisation, and the particular one of the database servers 102 to 108 that is selected as the child master database for the user.

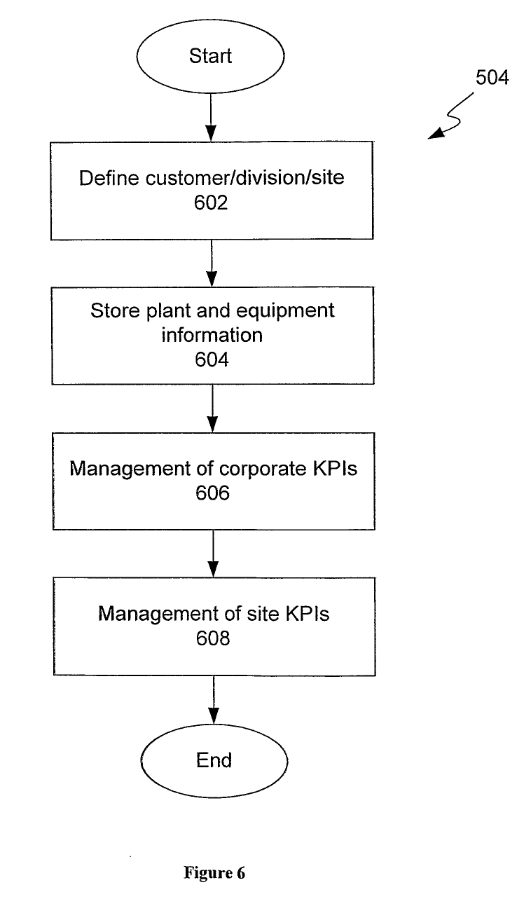

Once the user profiles have been created, a profile is created and managed for each customer of the organisation using a customer management process 504, as shown in FIG. 6.

At step 602, a customer profile is defined for each new customer of the organisation. Specifically, the following fields are stored in a Customers table of the back end database 204:
(i) the name of the customer;
(ii) an identifier of the organisation's brand under which the customer's account is managed (i.e., fuels or lubricants);
(iii) a bitmap image of the customer's logo;
(iv) an identifier of the internal lubricants owner of the account; and
(v) an identifier of the internal fuels owner of the account.

A customer may have several sites at which goods and/or services are to be provided by the organisation. A Sites table of the back end database 204 stores the following 6 fields for each site:
(i) an identifier of the customer the site is associated with;
(ii) the name of the site;
(iii) the customer's division the site is associated with;
(iv) the internal region (location) where the site is located;
(v) the internal lubricants owner of the account; and
(vi) an identifier of the internal fuels owner of the account.

At step 604, a list of relevant plant and equipment associated with each of the customer's sites is entered and stored in the back end database 204. This information is determined by plant surveys carried out at each of the customer's relevant sites. The storing of lists of each customer's plant and equipment allows the delivery of value to be linked to a specific piece of plant or equipment, enabling best practice and the transfer of knowledge from one site or customer to another.

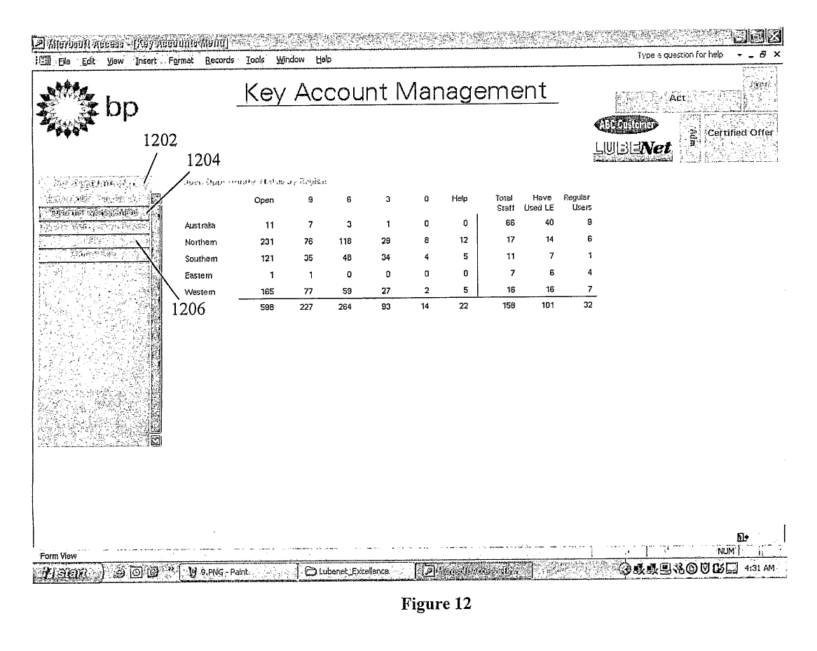

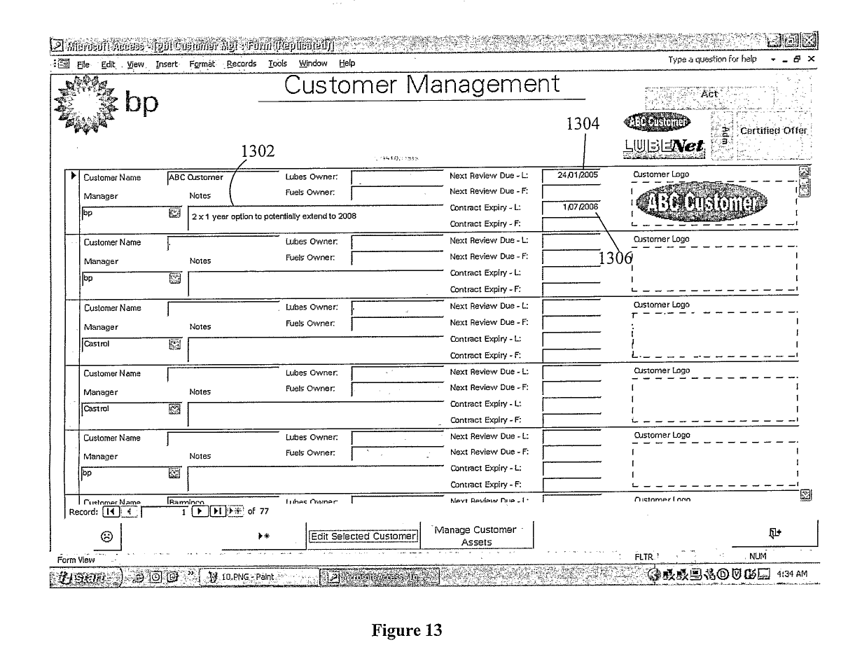

Returning to FIG. 10, selection of the Key Account Management Button 1010 causes a pop-up menu 1202 to be displayed, as shown in FIG. 12. Selection of a Customer Management menu item 1204 from the pop-up menu 1202 causes a customer management screen to be displayed, as shown in FIG. 13. The customer management screen includes a Notes text box 1302 that can be used to store any specific information relating to the customer, such as contract extension clauses. A Next Review Due text box 1304 provides the date upon which a review of the customers contract is due; this is used to promote and drive cost reductions in each account for the account owner to leverage with the customer. A contract expiry date text box 1306 allows the user to enter the expiry date for the relevant contract.

The value data system manages perceived opportunities for delivering value to customers of the organisation, also referred to herein as initiatives. The delivered value is represented by appropriate key performance indicators (KPIs), as described below, which are typically included as part of the organisation's contractual obligations to the customer. Throughout this specification, the word opportunity is used to refer to a perceived opportunity to deliver value to a customer, as described below. For example, an opportunity might be an initiative or proposal to replace one of the organisation's products or services with another, or to use a product in a different manner, or to otherwise restructure the activities of the organisation and/or the customer in order to provide direct or indirect cost savings, and/or reduce the environmental impact of the customer's activities, and/or reduce the customer's adverse social impact on the community, and/or to provide some other type of commercial, environmental, and/or social value to the customer.

Once a customer profile has been created, contract KPI objectives for that customer can be managed at Corporate and site levels at steps 606 and 608, including the recording of any assumptions that may impact the KPIs. KPIs are separately maintained for fuel & lubricant contracts for the same customer, allowing the management of accounts with a full understanding and knowledge of contractual obligations.

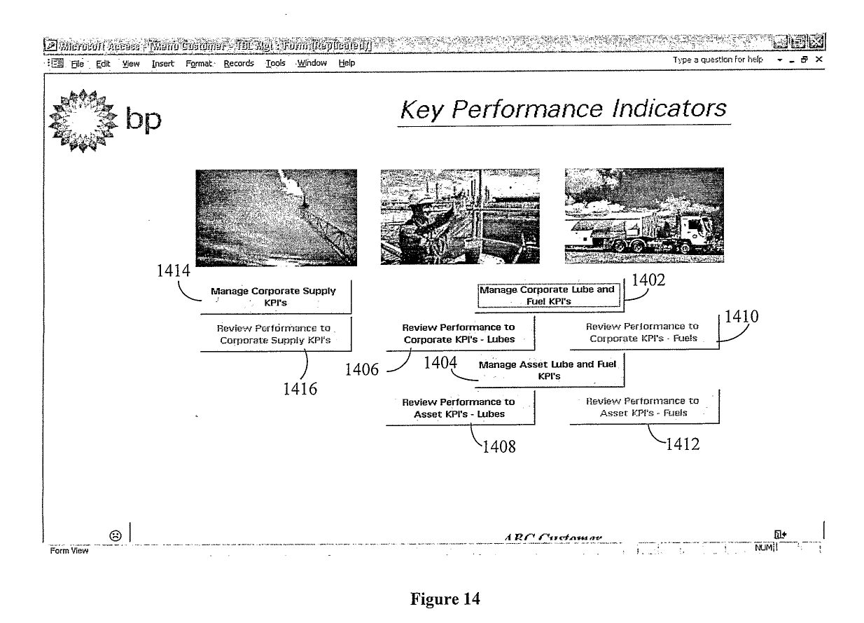

Returning to FIG. 12, selection of a KPIs menu item 1206 of the key account management menu 1202 causes a Key Performance Indicators screen to be displayed, as shown in FIG. 14. This page provides eight buttons 1402 to 1416 that can be selected to access respective KPI management functions provided by the value data system. As shown in FIG. 14, buttons 1410, 1412 relating to fuels only are disabled in this example because the selected customer does not have any relationship with the fuels brand of the organisation, but only to the lubricants brand. Accordingly, buttons 1406, 1408 relating specifically to lubricants are enabled, as are buttons 1402, 1404 relating to both lubricants and fuels.

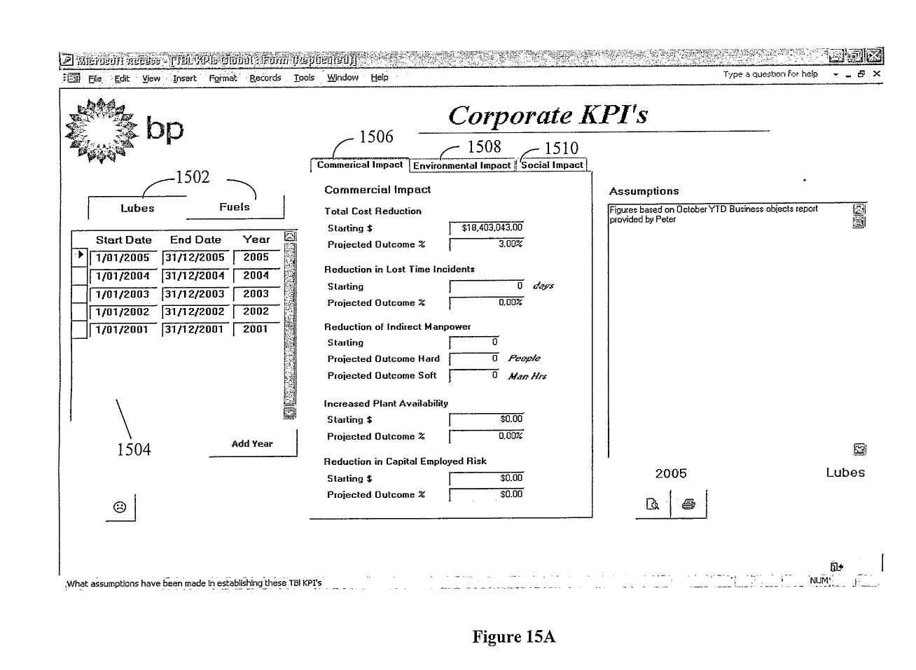

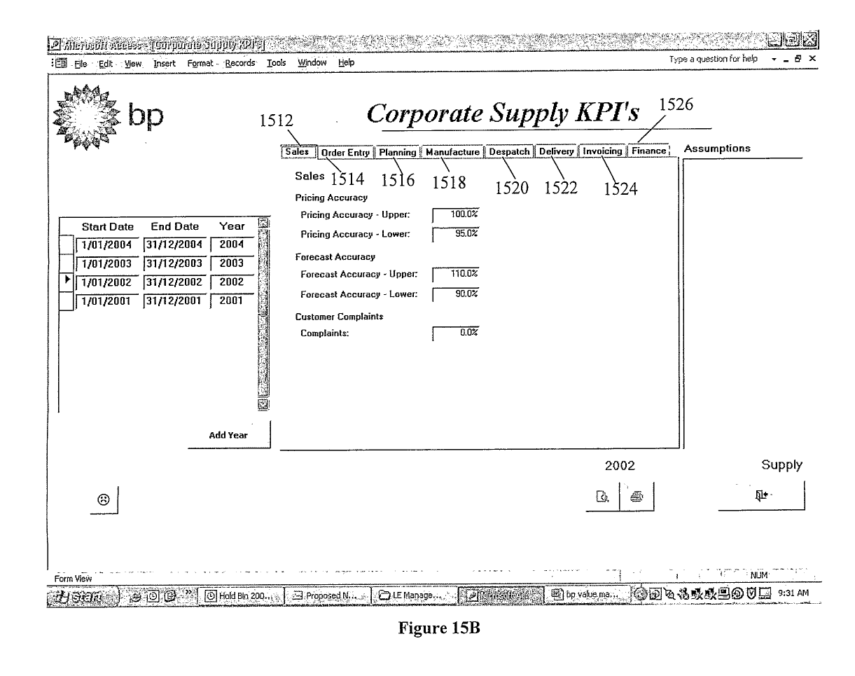

A Corporate Supply KPIs Management Button 1414 can be selected to access a Corporate Supply KPIs Management Screen, as shown in FIG. 15B, that is used to review and manage supply KPIs (indicating accuracy, complaints, review, compliance, and objectives) that have been agreed upon by the organisation and the customer. The Corporate Supply KPIs Management Screen provides sales, order entry, planning, manufacture, dispatch, delivery, invoicing, and finance tabs 1512 to 1526 that can be selected to review and manage the supply KPIs for respective supply activities.

Returning to FIG. 14, a Review Performance to Corporate Supply KPIs button 1416 can be selected to review performance to the Corporate Supply KPIs selection of a Manage Corporate Lube and Fuel KPIs button 1402 causes display of a corporate KPIs management screen, as shown in FIG. 15A. The corporate KPIs management screen provides account selection buttons 1502 allowing the user to select between lubricant and fuel accounts, where applicable, and a scrollable display box 1504 lists contract KPI periods for the selected customer. Three KPI tabs 1506 to 1510 provide access to text boxes for entering and displaying numeric values for commercial values, environmental values, and social values, respectively, for the selected customer.

Specifically, a commercial value tab 1506 can be selected to display KPIs for the following commercial value objectives:
(i) total cost reduction;
(ii) reduction in lost time incidents (LTI);
(iii) reduction of indirect manpower (e.g., support staff not directly involved in the project that is the subject of the relevant contract);
(iv) increased plant availability; and
(v) reduction in capital employed risk.

Each of these five items represents a measurable commercial value that can be provided to the customer by implementing the initiative or opportunity. Total cost reduction represents the measurable value resulting from the opportunity, and reflected in the total cost of ownership, and the remaining four items represent components of this. Reduction in capital employed risk refers to extending the useable life of an asset, and therefore reducing the need to invest capital for replacing assets. Each of these KPIs can be contractually mapped to affect the customer's corresponding general ledger code. The lost time incidents KPI can be linked to the customer's safety risk management plan.

An environmental value tab 1508 can be selected to display KPIs for the following environmental value components:
(i) reduction in emissions—air;
(ii) reduction in emissions—liquid;
(iii) reduction in emissions—noise;
(iv) reduction in emissions—solids; and
(v) project register, (i.e., a measurable activity that cannot be linked to any of the above categories; but that can be referenced to the environmental risk register as an act of due diligence).

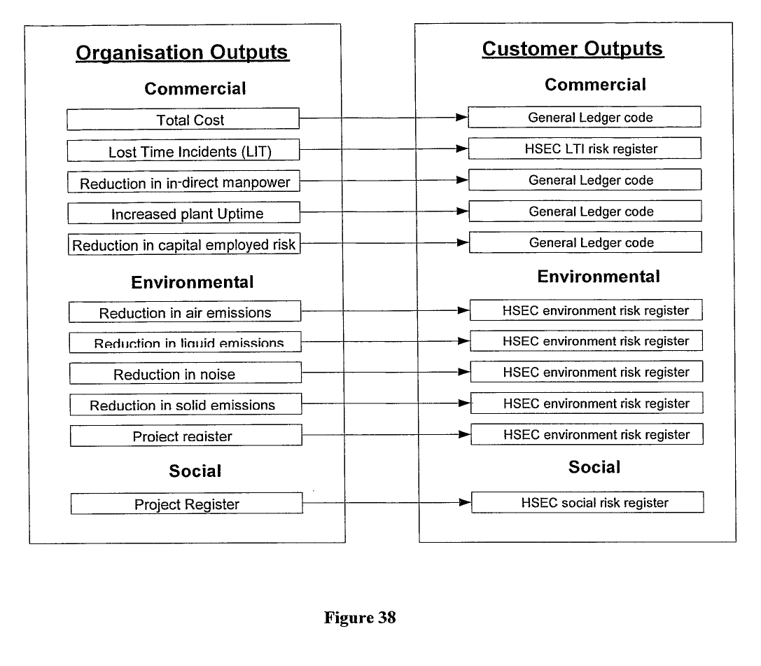

As shown in FIG. 38, each KPI is associated with a corresponding ledger code or Health Safety, Environment and Community (HSEC) risk register of the customer. It is a requirement of ISO14001 that each customer maintains a site-based risk register, and a management plan to mitigate the risks in that register. The emissions reduction and project register constitute mitigation strategies that support the customer's risk management plan and represent due diligence on the part of the customer.

The social value tab 1510 provides access to any KPIs of social value, and a project register (i.e., an activity that can be referenced to the customer's social risk register as an act of due diligence). This applies where the customer recognises their business impact socially through a risk management plan. A wide variety of KPIs can be used to represent social value. For example, the number and type of trucks travelling through a town on their way to and from one of the customer's sites can be represented as a KPI of social value, where the reduction of the number of truck passages through the town is considered to provide not only environmental value but also social value by reducing the adverse impact on the local community in terms of low-level pollution, noise, and wear and tear on the road infrastructure. It will be apparent that, in general, social value KPIs will be determined by the type of business carried out by the organisation and/or by the customer. Another example of social value is to assist a customer who is working with the community to reduce the social impact of the customer's business. For example, in the case of an organisation providing petroleum products, the impact of petrol sniffing in the community can be reduced by providing fuel to the customer with reduced or no aromatic chemical compounds so that the fuel causes few or no pleasurable effects when sniffed. By ensuring the delivery of such social values to the customer (in addition to the environmental values described above), the system thereby ensures the provision of substantial social benefits to the wider community.

Once the various KPI values have been agreed upon by the organisation and the relevant customer, the system generates a report for sign off by both parties, thereby creating a working document of the expectations on the organisation. The commercial, environmental, and social values can be considered to define a triple bottom line for the customer.

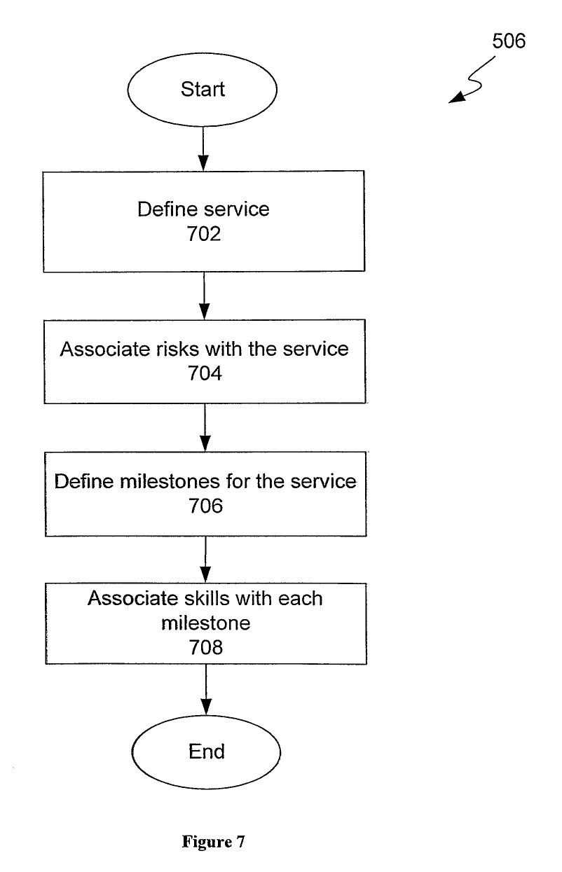

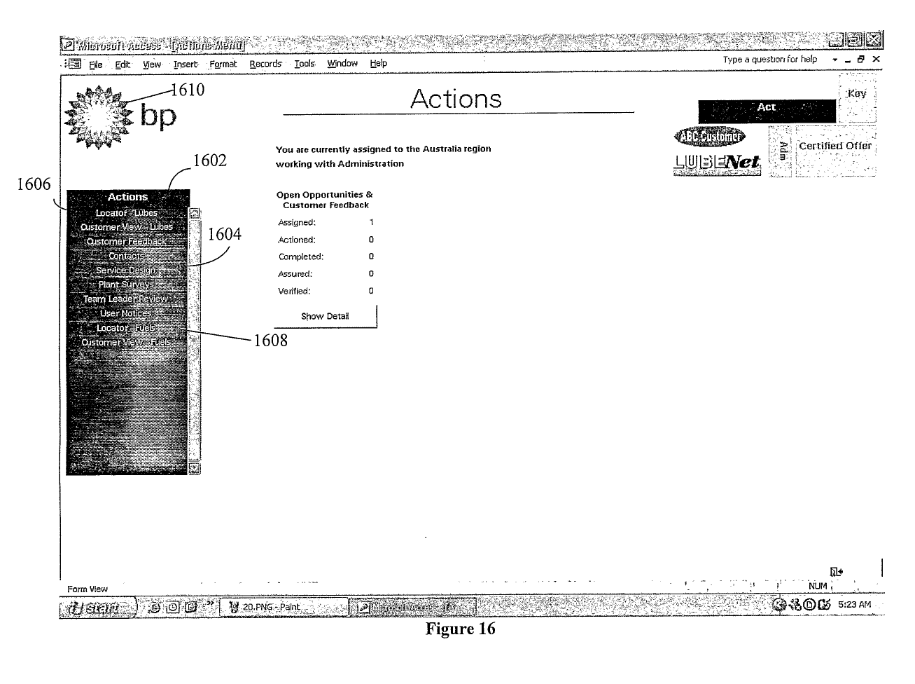

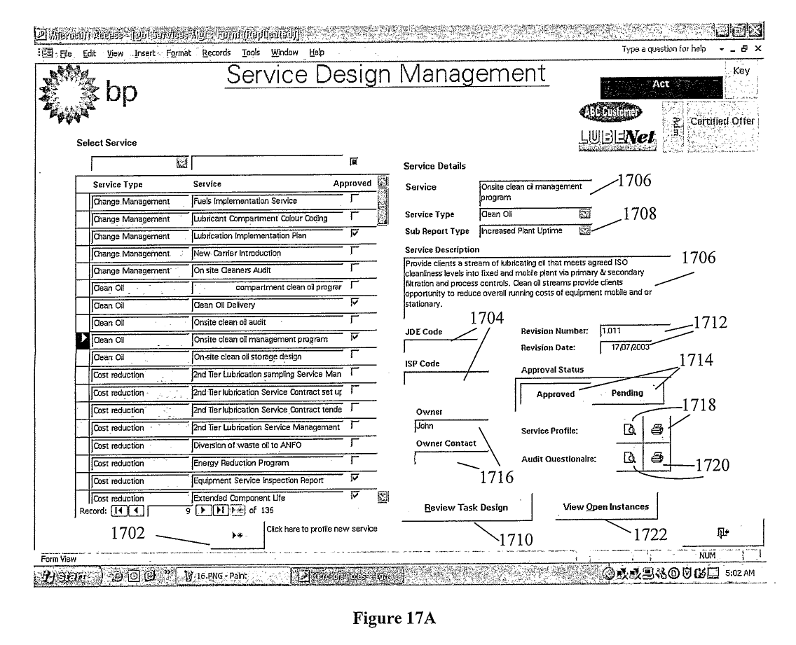

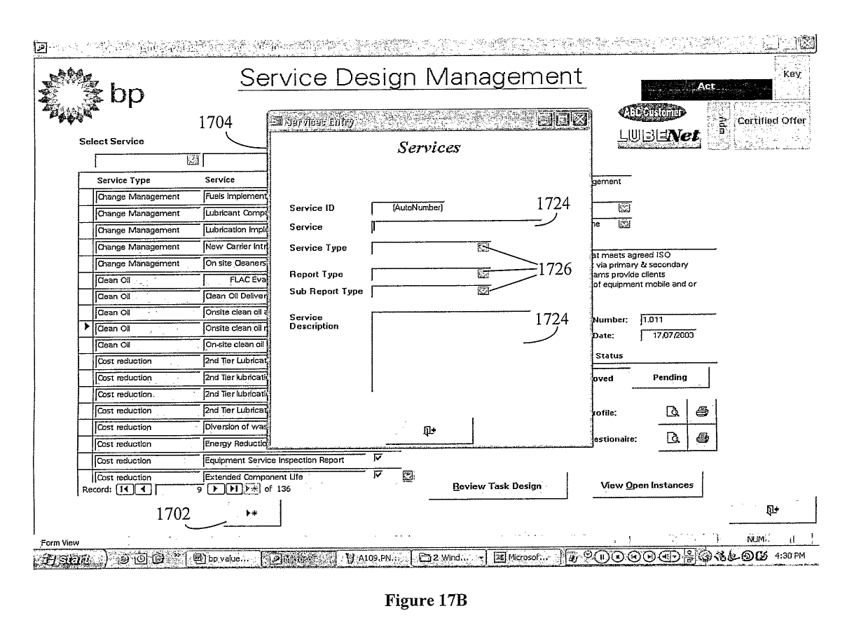

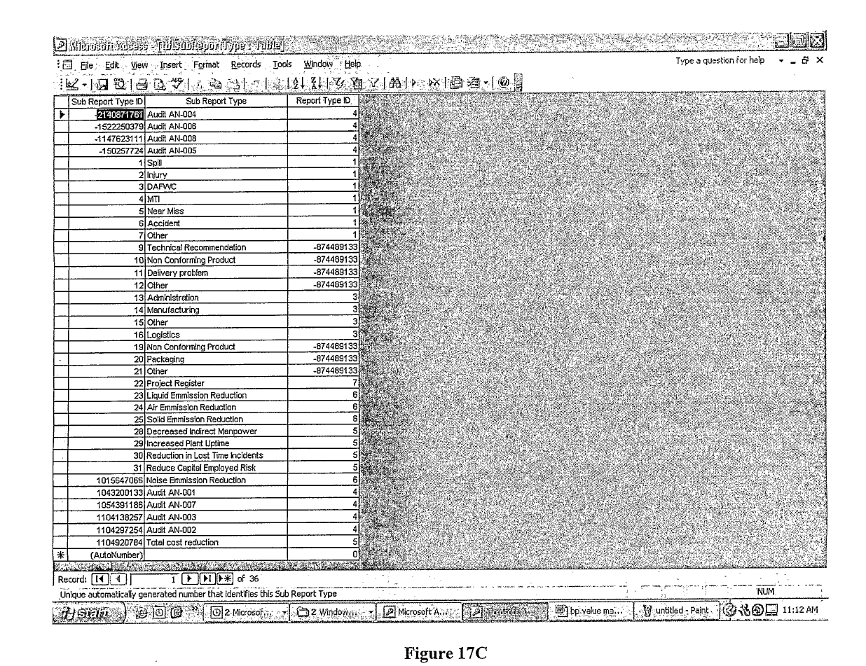

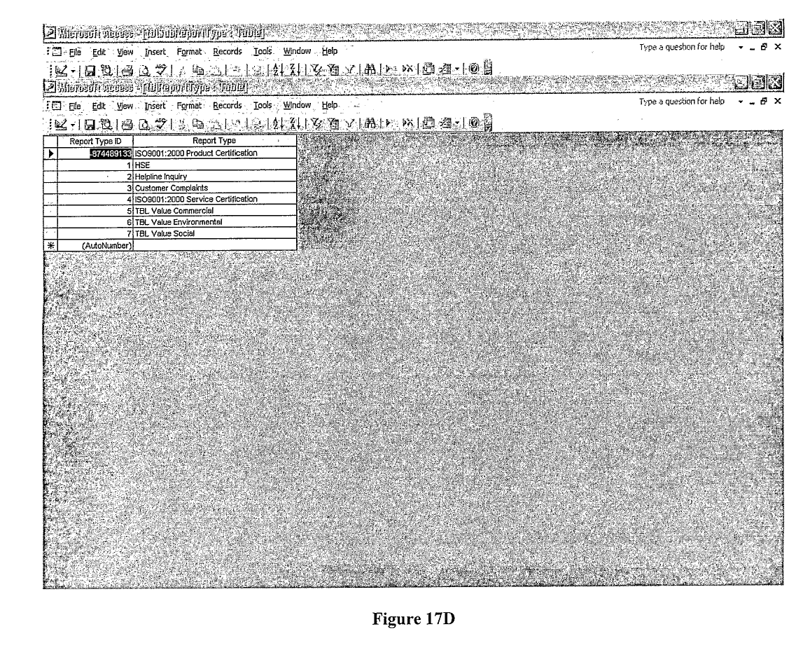

Returning to FIG. 5, each initiative/opportunity managed by the value data system is a specific instance of a selected generic initiative/opportunity known to the system and referred to herein as a service or task. At step 506, individual generic services are defined using a service design process 506, as shown in FIG. 7. To access the service design process 506, the user selects the Action button 1008 displayed on the main screen, which causes a pop-up Action menu 1602 to be displayed, as shown in FIG. 16. Selection of a Service Design menu item 1604 causes a service design management screen to be displayed, as shown in FIG. 17A.

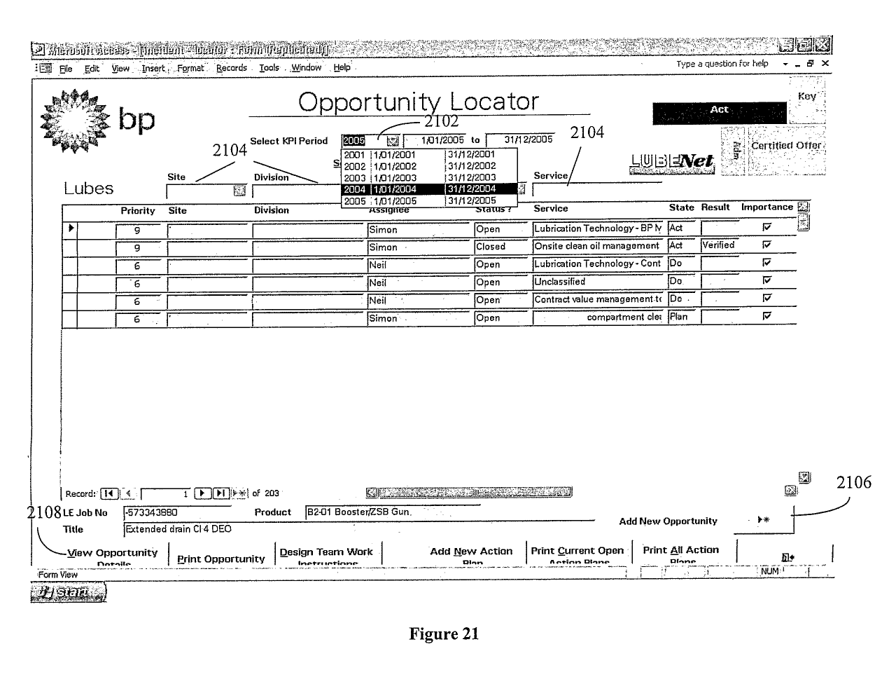

The service design management screen displays in a scrollable list all services known to the system grouped by service type. On selecting a service from the list, the details of the selected service are displayed in a Service Details panel, including the Service Type and Service description, and a pull down menu 1708 displaying the Sub Report Type for the service, being the internal sub-report category affected by the service. The sub-report category is used for internal reporting only and is selected as one of 36 available categories, as shown in the database table of FIG. 17C, including audits, spills, near miss, increased plant uptime, administration, project register, and so on. Each of the 36 sub report categories is associated with one of 8 available report categories, as shown in the database table of FIG. 17D. Returning to FIG. 17A, JDE and ISP Code text boxes 1704 allow the relevant internal product codes to be entered (if an internal product code has been created for the relevant service by the organisation), thereby allowing the capability of a service to be charged to a customer if required. Revision Number and date text boxes 1712 display the last time the service definition was last reviewed and its current revision number. Approval status radio buttons 1714 indicate whether the service is approved for use or is pending. Owner and Owner Contact Details text boxes 1716 indicate the responsible person authorised to manage and review the service. Service Profile view and print buttons 1718 can be used to view or print a report outlining the service. Audit Questionnaire view and print buttons 1720 can be used to view or print an audit questionnaire that is used to audit a service against a completed or in progress opportunity to ensure compliance to the quality standards QS9001:2000. A View Open Incidents button 1722 can be selected to display all open opportunities linked to the specified service in a view similar to that shown in FIG. 21.

Returning to FIG. 17A, a new service can be defined at step 702, by selecting a New Service button 1702, which results in display of a new service window 1704, as shown in FIG. 17B. This window 1704 allows the user to define a new service by entering a name and description of the service in respective text boxes 1724, and to select a service type, report type, and sub-report type for the new service, from respective pull-down menus 1726. For example, the Tables in Appendices 1 and 2 below list of all service types and services defined by the petroleum organisation. Other organisations will define services and service types relevant to their respective businesses.

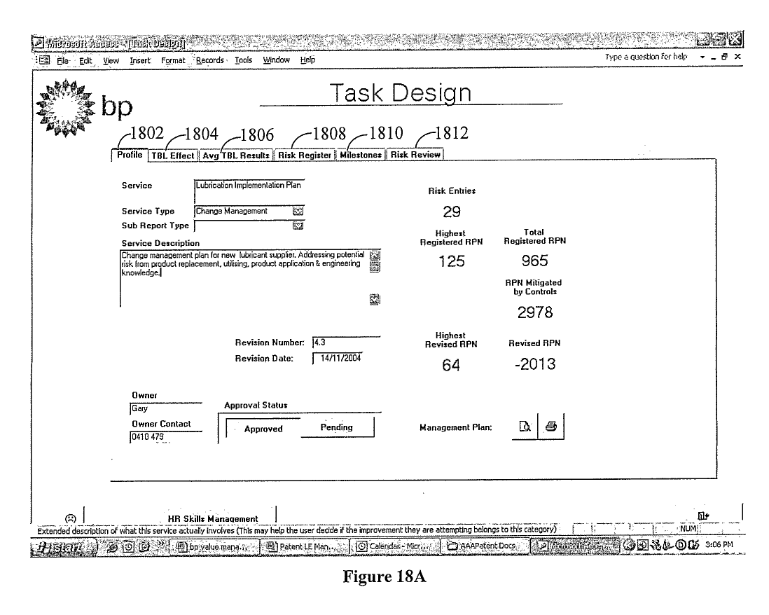

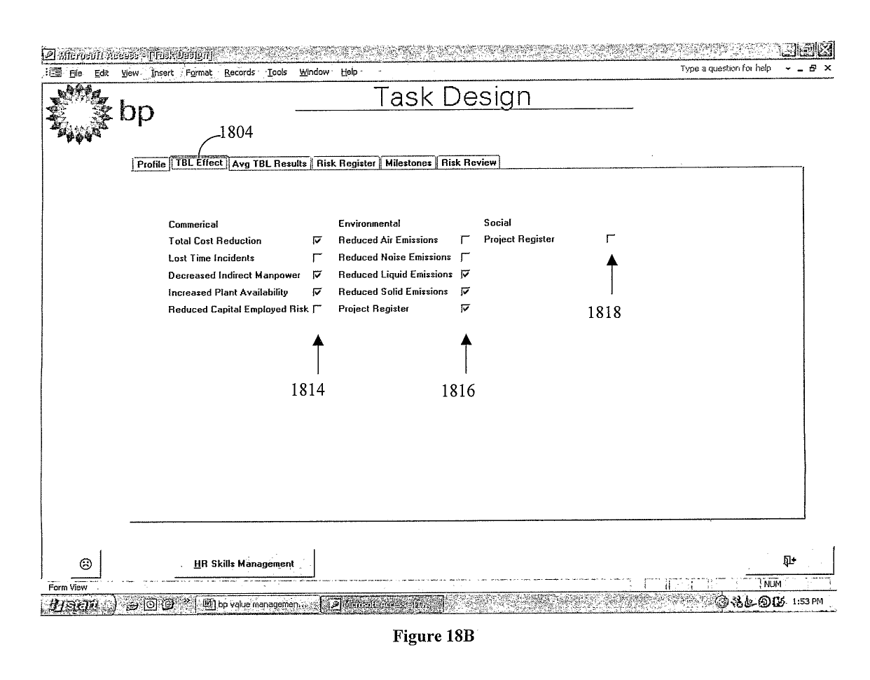

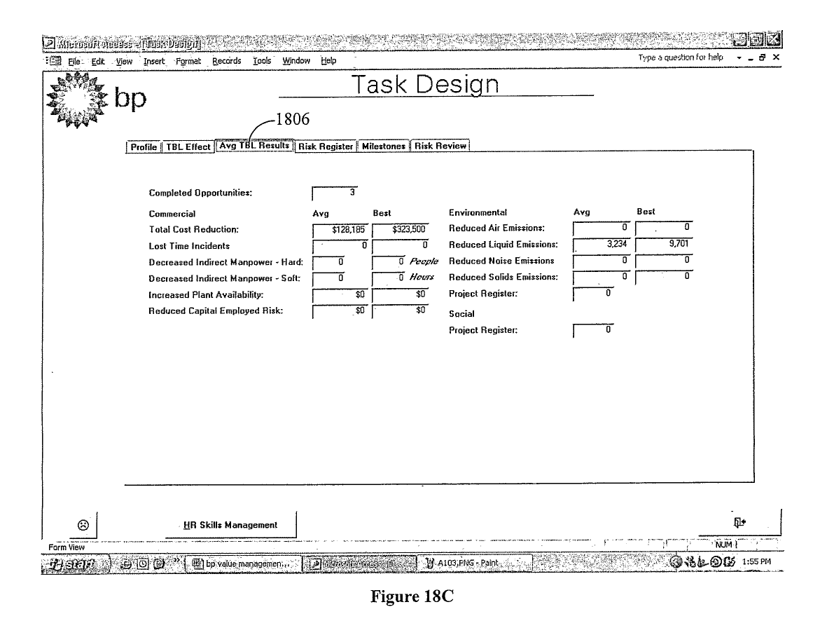

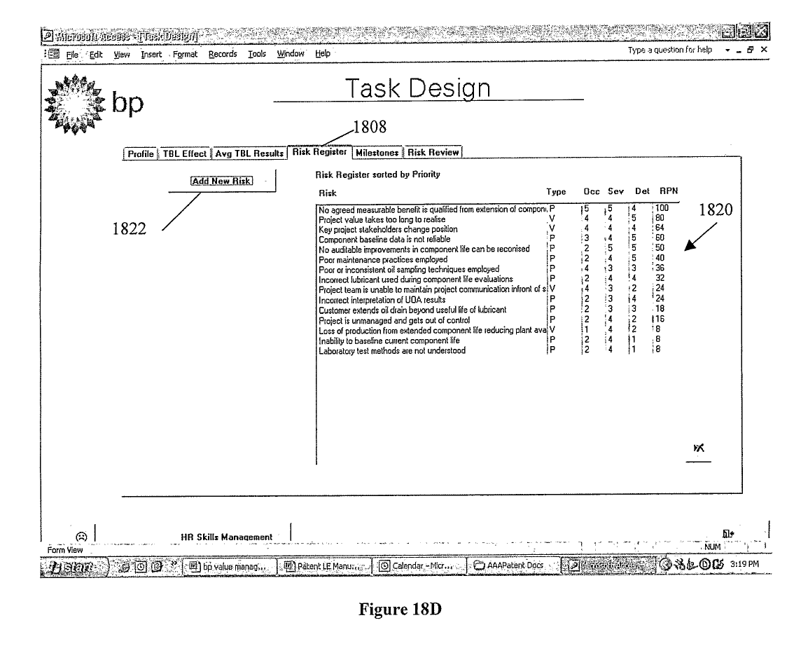

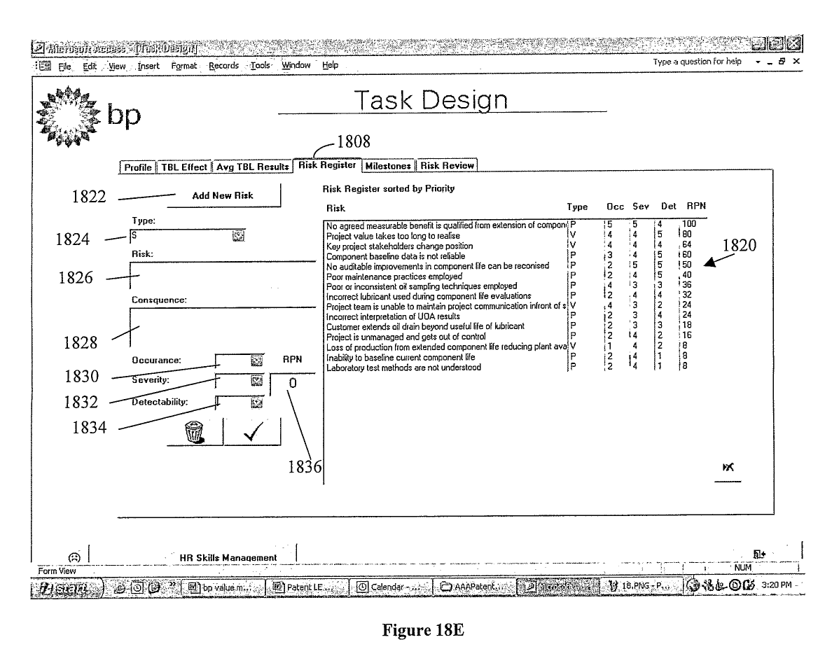

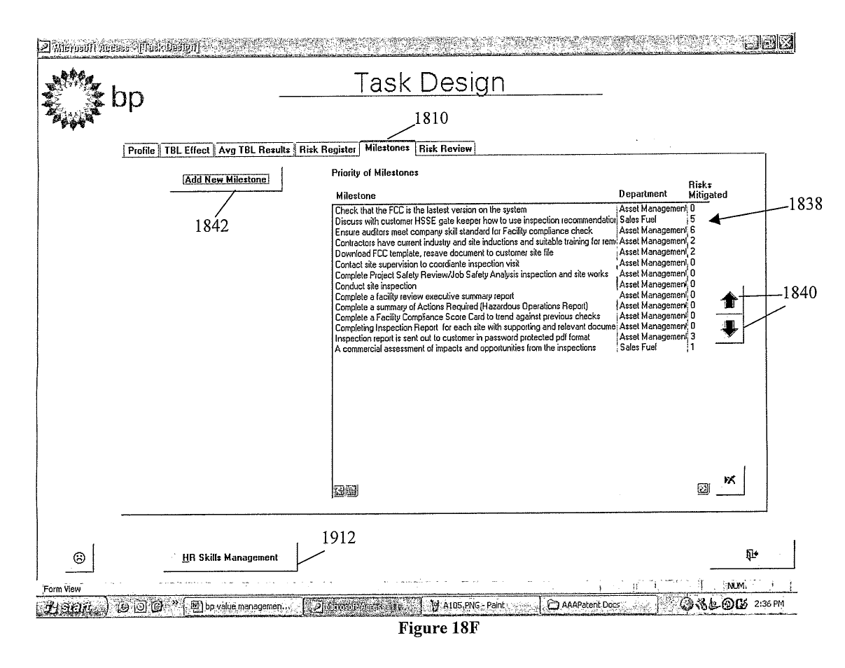

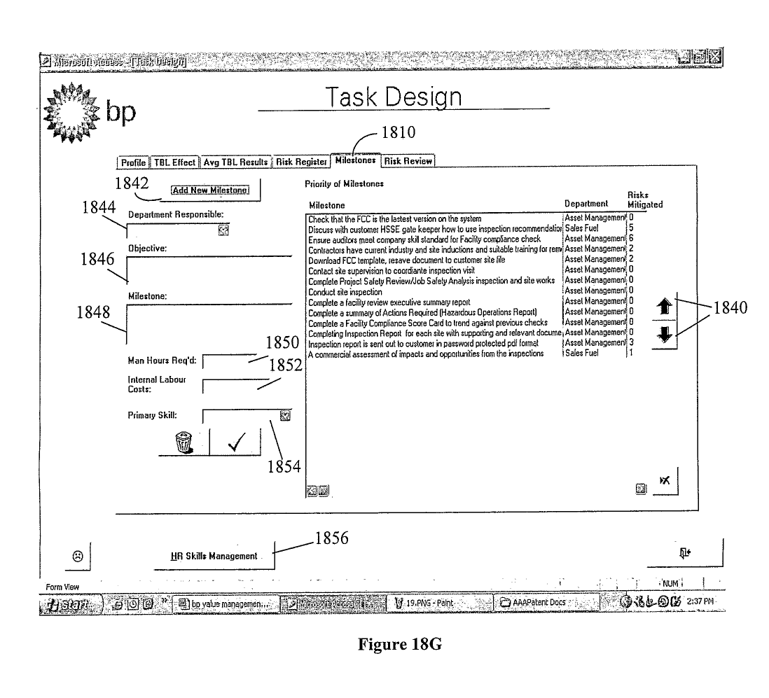

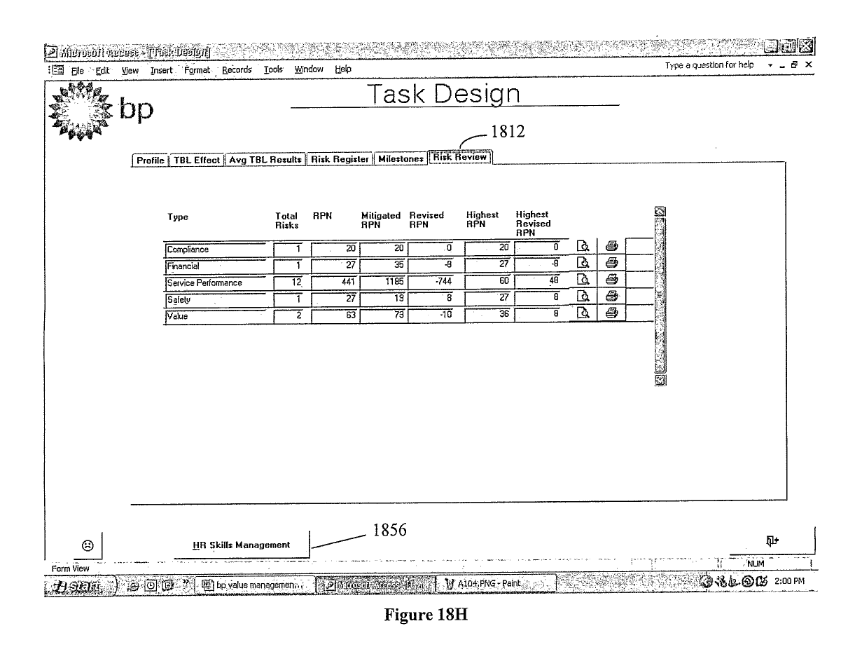

Having defined any new services, those services are further configured by selecting a Review Task Design button 1710, which causes a Task Design screen to be displayed, as shown in FIG. 18A. (The word “task” in this context being an alternative name for a service). The Task Design screen provides six tabs 1802 to 1812 that allow the user to access respective panels for defining, reviewing, and/or changing various aspects of the new service/task. In particular, risks associated with each service are defined, reviewed, and managed at step 704. The risks associated with a particular service are determined by a working group managed by the service owner.

As shown in FIG. 18A, a profile tab 1802 provides access to high level information on a selected service, including the service name, service type, and service description. This panel profiles the Risk Priority Number (RPN) rating to Australian Standard AS4360, as described below.

As shown in FIG. 18B, a Triple Bottom Line (TBL) effect tab 1804 allows the user to identify components of the TBL that are affected by the selected service by checking appropriate ones of the commercial values check boxes 1814, the environmental values check boxes 1816, and/or the social project register check box 1818.

As shown in FIG. 18C, an Average TBL Results tab 1806 can be selected to access a panel that allows the user to enter, review, and/or modify the values realised for each of the TBL categories for the selected service by averaging the results for all opportunities using that service. The average and best values for each value component are displayed. This provides a convenient and useful evaluation of the effectiveness of the selected service in providing value.

As shown in FIG. 18D, a Risk Register tab 1808 can be selected to review or modify risk data representing risks associated with the selected service by selecting from a list 1820 of risks sorted by priority. The list 1820 includes six columns for each risk, providing a risk description, type, occurrence score, severity score, detectability score, and risk priority number (RPN), as described below.

As shown in FIG. 18E, a new risk can be defined by selecting an Add New Risk button 1822, which results in the display of new risk controls 1824 to 1836, allowing the new risk to be defined for the selected service. A risk type pull-down menu 1824 allows the user to select the type or category of the risk. The risk register is formatted to comply with AS4360, and each risk is categorised by selecting one of the following risk types:
(i) financial (a risk relating to exposure of a financial nature);
(ii) environmental (a risk impacting or causing environmental consequences);
(iii) safety (a risk pertaining to employees, contracts, or the general public);
(iv) compliance (a risk pertaining to statutory compliance requirements);
(v) value from specific service (a risk of jeopardising the value delivered by the opportunity); or
(vi) performance of the activity: a risk relating to jeopardising the activity associated with the opportunity.

A Risk Description text box 1826 and a Risk Consequence text box 1828 are provided to allow a user to enter a textual description of the risk and its consequences. Pull-down menus 1830, 1832, and 1834 are provided to select occurrence, severity, and detectability scores for the risk, each being a score from 1 to 5. The occurrence score indicates the likelihood that the risk event will occur, from 1 (unlikely to occur) to 5 (likely to occur). The severity score indicates the severity of the impact of the risk event, from 1 (low impact) to 5 (high impact). The detectability score indicates the expected detectability, from 1 (likely to detect) to 5 (unlikely to detect). A Risk Priority Number (RPN) is automatically generated for each risk as the numeric product of the occurrence, severity, and detectability scores, and the resulting RPN is displayed in an RPN box 1836. The higher the RPN, the more significant the risk.

Each service is associated with task data representing a corresponding sequence of milestones, being the activities/tasks that are performed to effect or perform the service. Once one or more risks have been associated with the service, a sequence of milestones or activities, including activities that mitigate those risks, are then defined at step 706. As shown in FIG. 18F, a Milestones tab 1810 can be selected to define, review, and/or modify task data representing the sequence of tasks or milestones associated with the selected service. This sequence directly mitigates risk to the Australian risk assessment standard AS4360 by performing the milestone activities in the required sequence, thus supporting the organisation's internal auditing standards. Order modification buttons 1840 allows the user to change the execution order of the milestones defined for the service.

A new milestone is defined by selecting an Add New Milestone button 1842. This causes display of Milestone definition controls 1844 to 1854, as shown in FIG. 18G. An objective text box 1846 allows the user to define the objective of the milestone, and a milestone text box 1848 allows the user to enter a textual description of the milestone. An estimated time frame for performing the milestone is defined by entering the number of man-hours required in a text box 1850. A Responsible Department pull-down menu 1844 allows the user to associate a particular department of the organisation with the milestone, and an Internal Labour Costs text box 1852 enables definition of labour costs internal to the organisation for performing the milestone.

The mitigation of a risk via one or more milestones reduces one or more of the occurrence, severity, and/or detectability scores for that risk, effectively reducing the RPN for that risk. The lower RPN is referred to as a ‘Revised RPN’, with the difference between the original RPN and the Revised RPN being referred to as the ‘Mitigated RPN.’ As shown in FIG. 18H, selection of a Risk Review tab 1812 provides a convenient summary of the Risk Priority Number (RPN) for each risk type category associated with the service in terms of the RPN, revised RPN, highest RPN, and the number of risks profiled. The values for each risk type category are generated by summing the values for each risk in that category.

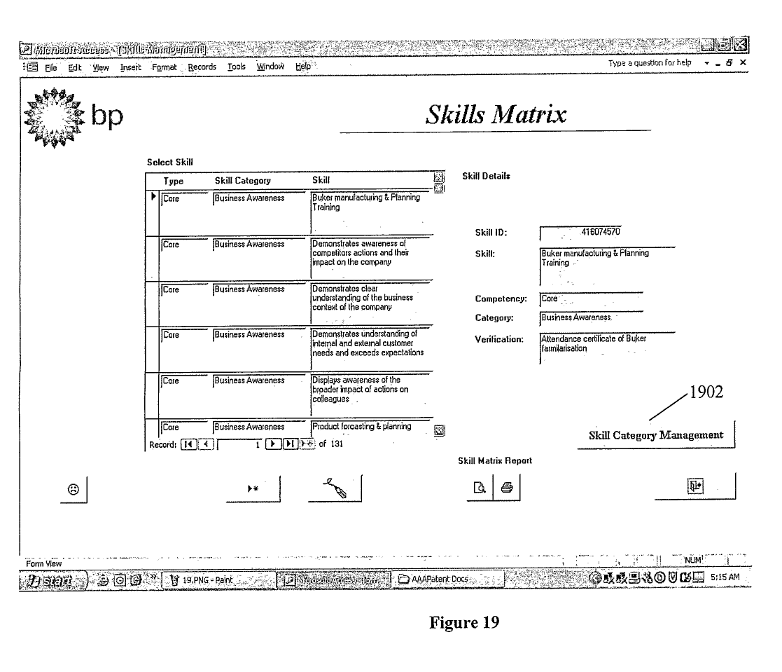

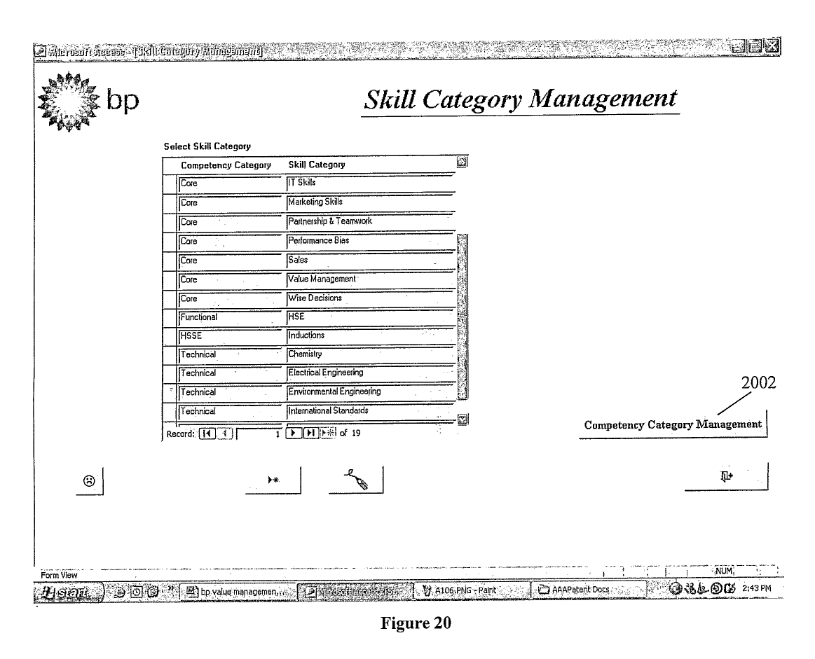

Returning to FIG. 18G, each milestone is associated with a particular skill at step 708 via selection of a primary skill menu 1854. Selection of an HR skills management button 1856 causes display of a skills matrix screen, as shown in FIG. 19. This allows the user to enter, modify, or view a list of skills known to the system, or to create or modify those skills. Each skill is given a numeric identifier, a descriptive name, and is classified by skill category (e.g., business awareness, etc.). Each skill category, when profiled, is linked to a competency category (e.g., core business, HSSE, functional/sales, or technical. Verification text associated with each skill indicates how the skill can be verified. Skill categories and competencies are defined using Skill Category Management and Competency Category Management screens. For example, selection of a Skill Category Management button 1902 causes the system to display a Skill Category Management screen, as shown in FIG. 20, which allows the user to define, review and/or modify the skill categories associated with each competency category. The competency categories themselves can be defined using a Competency Category Management screen accessed by selecting a Competency Category Management button 2002. This completes the service design process 506. On completion of the service design, the service is approved using the organisation's internal Service Design Procedure to ensure that expertise from commercial, environmental, safety and statutory compliance risk review the service prior to release to the organisation for use.

If desired, the system can automatically generate:
(i) a design teamwork instructions (service profile) form profiling the service, risk register, work instruction and audit questions and full set of skill requirements to complete such a service;
(ii) an audit questionnaire outlining a full set of questions required to be asked to perform the activity;
(iii) a complete risk management plan describing risks and mitigations associated with performing the activity; and/or
(iv) a full skills matrix report outlining the skills required to perform the activities.

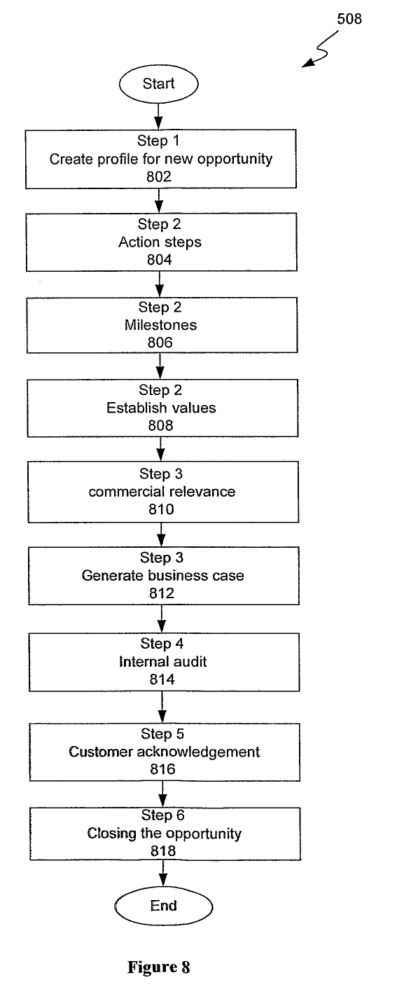

Returning to FIG. 5, after the user, customer, and service profiles have been created at steps 502 to 506, users of the value data system can create and manage opportunities for delivering value to the organisation's customers via an opportunity management process 508, as shown in FIG. 8.

At a high level, each opportunity is managed using the following five major steps:
first, define the scope of the opportunity and then:
(i) Major Step 1: Profiling the Opportunity: plan the opportunity using milestones to achieve the specific activity;
(ii) Major Step 2: Action/Activity: enter information on the opportunity that can be included in a business case document. The business case document should be developed with the customer during the whole process of implementing the opportunity;
(iii) Major Step 3: Commercial Relevance: determine the process by which the value resulting from implementing the opportunity will be measured;
(iv) Major Step 4: Internal Audit: an internal verification process ensures that all details are correct; and
(v) Major Step 5: Customer Acknowledgement: the customer acknowledges the value provided by the opportunity.

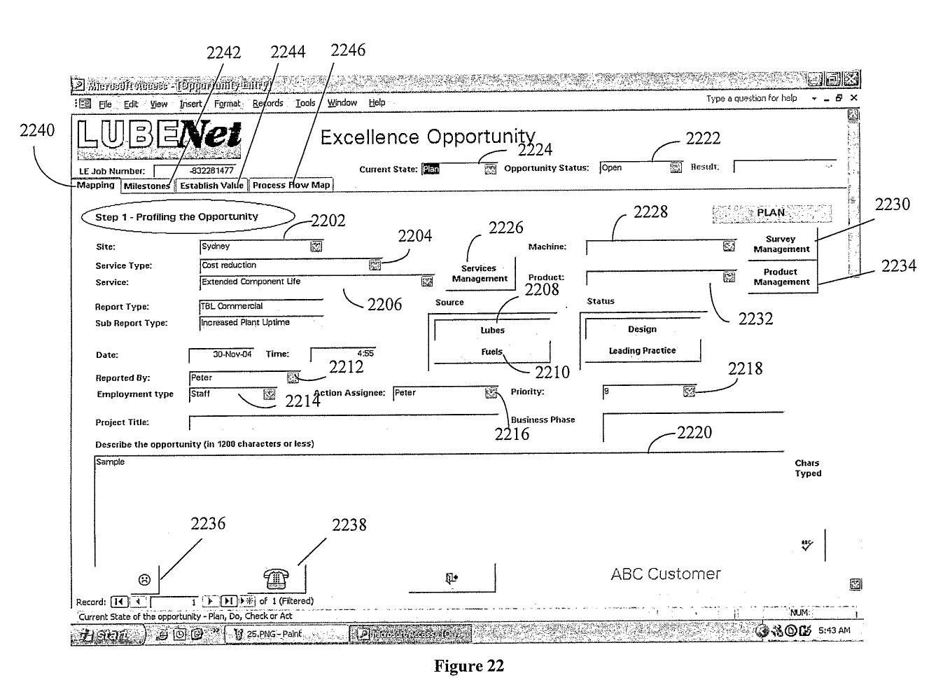

To perform the first of these five major steps, the opportunity management process begins at step 802 by defining initiative data to create or edit a profile for an opportunity/initiative. As shown in FIG. 16, this is achieved by selecting a Locator-Lubes menu item 1606 or a Locator-Fuels menu item 1608, as appropriate, from the Action menu 1602. This causes display of an Opportunity Locator screen, as shown in FIG. 21. By default, this screen displays a list of all open opportunities defined for the selected customer, and any closed opportunities that were closed within the KPI period selected from a KPI period menu 2102. However, it is possible to filter the displayed opportunities by site, division, assignee, status, and/or service by using opportunity filter controls 2104. Opportunities are displayed in priority order, as described below. A new opportunity can be added by selecting an Add New Opportunity button 2106, and an existing opportunity can be viewed or edited by selecting the displayed opportunity from the list, and then selecting a View Opportunity Details button 2108, causing display of an Opportunity Details screen, as shown in FIG. 22. The Opportunity Details screen provides a Mapping tab 2240, a Milestones tab 2242, a Establish Value tab 2244, and a Process Flow Map tab 2246 for accessing respective panels of the screen. As shown in FIG. 22, the Mapping tab 2240 displays basic information used to profile the opportunity.

When creating a new opportunity/initiative, the relevant site for the customer is selected from a pull-down site menu 2202, the service type is selected from a service type pull-down menu 2204, and the specific service is then selected from a service pull-down menu 2206. A Service Management button 2226 can be selected to access the Service Design Management screen described above and shown in FIG. 17A.

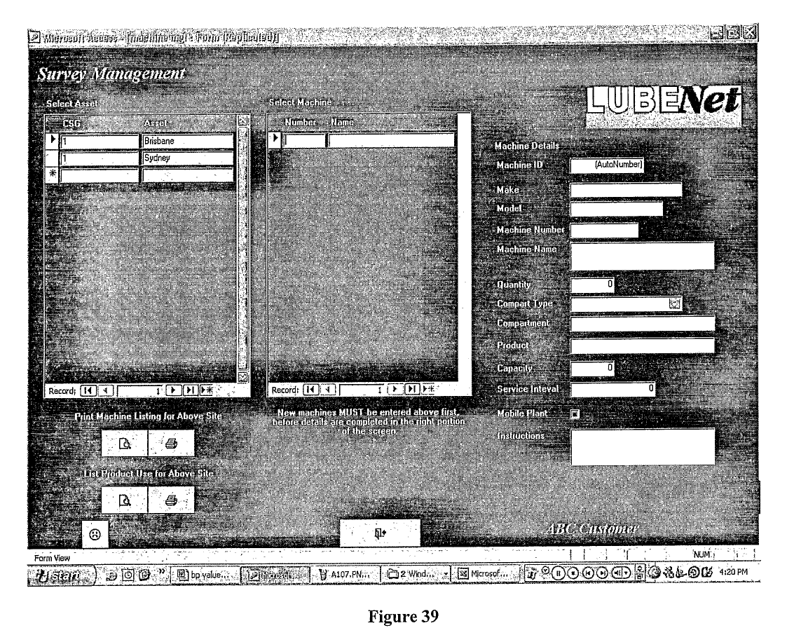

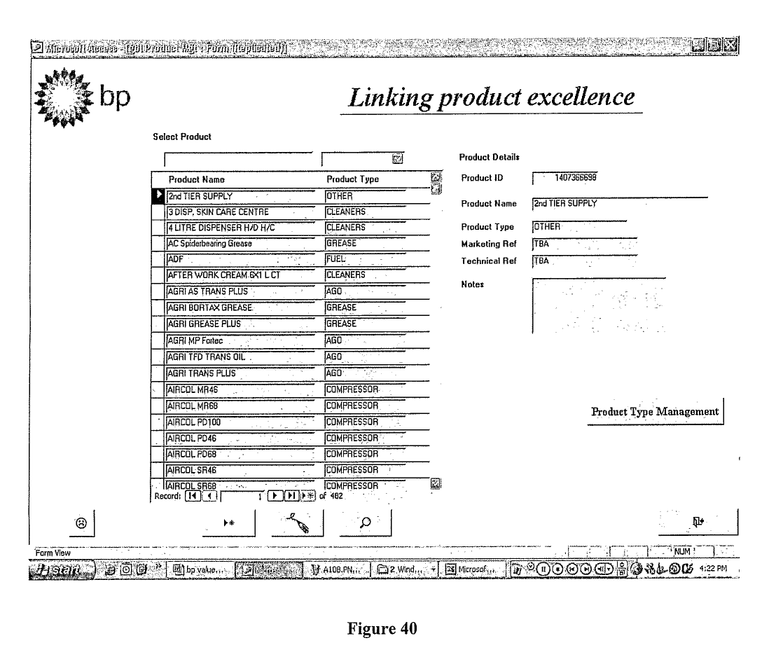

Returning to FIG. 22, opportunities can be linked to a customer's plant or equipment by selecting the appropriate items of plant or equipment from a Machine drop down menu 2228. A customer's plant or machine is identified by the Plant Surveys performed at step 604, which are linked to the opportunity by selecting a Survey Management button 2230 to access a Survey Management Screen, as shown in FIG. 39. Opportunities can also be linked to the organisation's internal products by selecting from a Products drop down menu 2232 or by selecting a Product Management button 2234 to define a new product using a Product Management screen, as shown in FIG. 40. Returning to FIG. 22, a source group box provides a Lubes button 2208 and a Fuels button 2210, and one of these is selected to indicate whether the opportunity relates to the Lubrications or Fuel brands of the organisation. A Reported By pull-down menu 2212 allows the user to select their name as the user who initially reported the opportunity. An Employment Type pull-down menu 2214 allows the user to specify whether that person is a staff member or a contractor. An Action Assignee pull-down menu 2216 is used to define the owner of the opportunity; i.e., the person who takes responsibility for its management. A Priority drop down menu 2218 allows the user to assign a numeric priority level to the opportunity, based on the following priority rating criteria.

### Opportunity Priority Rating:

(i) Priority 9 High Focus—Set by the opportunity owner in conjunction with the account negotiator to ensure commercial leverage;
(ii) Priority 6 High Priority—Set by the opportunity owner (assignee);
(iii) Priority 3 Medium Priority—Set by the opportunity owner (assignee);
(iv) Priority 0 Low Priority—Set by the opportunity owner (assignee).

Finally, a description of the opportunity in 1200 characters or less is entered into an opportunity description text box 2220. An Opportunity Status pull-down menu 2222 allows the user to specify whether the opportunity is open or closed, and a Current State pull-down menu 2224 allows the user to define the state of the opportunity from one of the four states of the Deming cycle, namely:
(i) PLAN (the opportunity is reported/profiled but not started);
(ii) DO (the opportunity is being investigated and/or actioned);
(iii) CHECK (the activity has been completed, but has not been internally verified); and
(iv) ACT (internal verification complete; customer to sign off the opportunity).

The opportunity status, current state, and result fields (described below) are used to monitor and report on the progress of each opportunity and thus it is important to ensure that these fields are updated as the opportunity is progressed. This allows accurate reporting on the progress of opportunities to the business and to the customer.

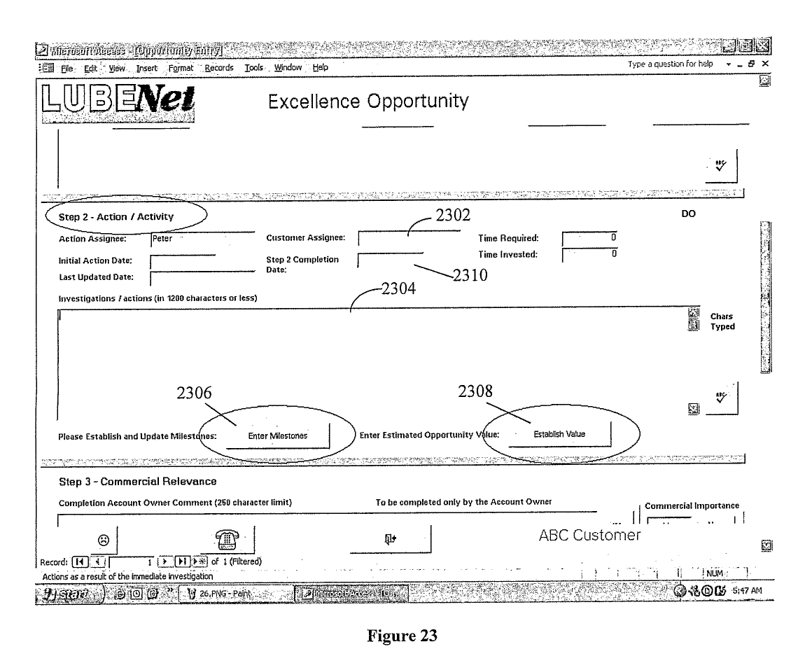

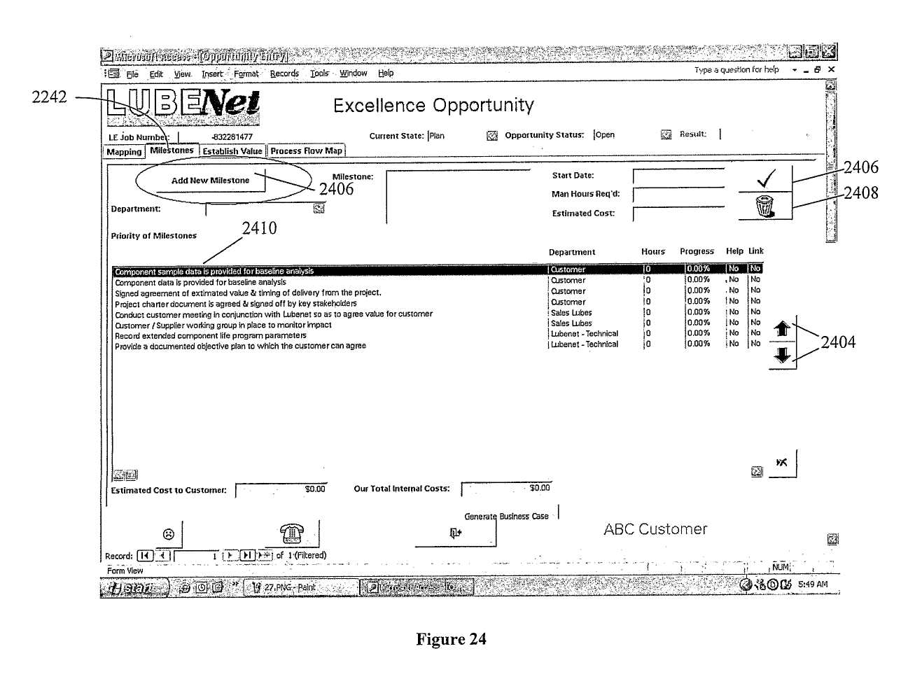

After the profile for the opportunity has been completed at step 802, the opportunity can be actioned at step 804 by changing the current state of the opportunity from Plan to Do, using the current state pull-down menu 2224, as shown in FIG. 22. The system then manages the corresponding activity steps through activity milestones and establishing value. As shown in FIG. 23, the name of the customer contact on site that the opportunity is being worked with is entered into a Customer Assignee text box 2302. An Investigations/Actions text box 2304 is provided for the user to enter comments relating to the current progress of the initiative or the investigations and actions resulting from the activity; these comments should reflect the milestones. An Enter Milestones button 2306 is selected to list and manage the steps required to complete the opportunity, as shown in FIG. 24. This panel can alternatively be accessed by selecting the Milestones tab 2242. Selection of an Add New Milestone button 2402 adds a sequence of default milestones to the opportunity, being the milestones previously defined for the corresponding service at step 706 (if no milestones are yet defined) or adds a new milestone (if one or more milestones have already been entered). The user can thus add any milestone to the opportunity that was not included within the default milestones defined previously for the service selected for this opportunity. For each milestone, the user can view or modify: the department responsible for the milestone, a description of the milestone step, the start date that is entered when the milestone activity commences, the total number of man-hours taken to complete the milestone, and the estimated internal and external cost to the customer to implement the milestone. The order of milestones in the list can be modified by selecting from ordering buttons 2404. A selected milestone can be accepted by selecting a select milestone button 2406, or deleted by selecting a delete milestone button 2408.

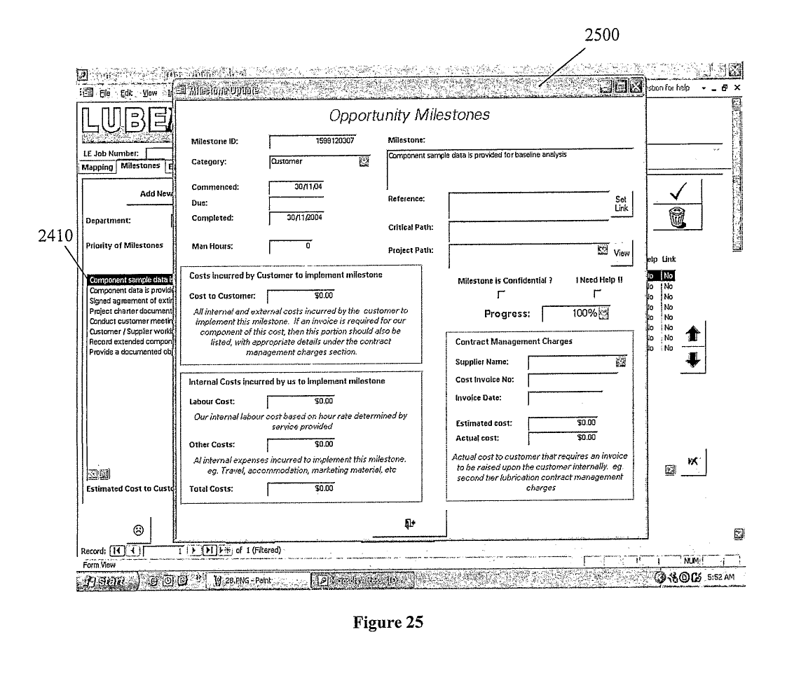

Each milestone thus defined for the opportunity can be managed independently by double clicking the milestone from the displayed list, causing an Opportunity Milestones window 2500 to be displayed, as shown in FIG. 25.

The following fields are displayed in the Opportunity Milestone window 2500:
(i) Commenced (the date the milestone was actioned);
(ii) Completion (the date the milestone was completed);
(iii) Hours (total number of man-hours taken to complete the milestone);
(iv) Reference (supporting documentation attached to the opportunity via a hyperlink);
(v) Help (a check box indicating whether Help is required by the department selected to complete the milestone);
(vi) Confidential (a check box that can be selected to hide the milestone from the business case);
(vii) Progress (the current percentage progress of the milestone, being selected as one of: 0%, 25%, 50%, 75%, and 100% complete);
(viii) Cost incurred to Customer (all internal and external cost to the customer to implement the milestone; Note: these costs are not invoiced to the customer);
(ix) Cost incurred to us (all internal and external cost to the organisation to implement the milestone, broken up into Labour and Expenses; Note: this should form part of the minimum cost saving to the customer); and
(x) Contract Management Charge (this field is used for and to control charges that are required to be invoiced to the customer i.e., 2^{nd} tier services).

These costs are used to manage the cost of implementing each milestone and to determine whether the cost of implementing the opportunity is expected to outweigh the resulting benefit.

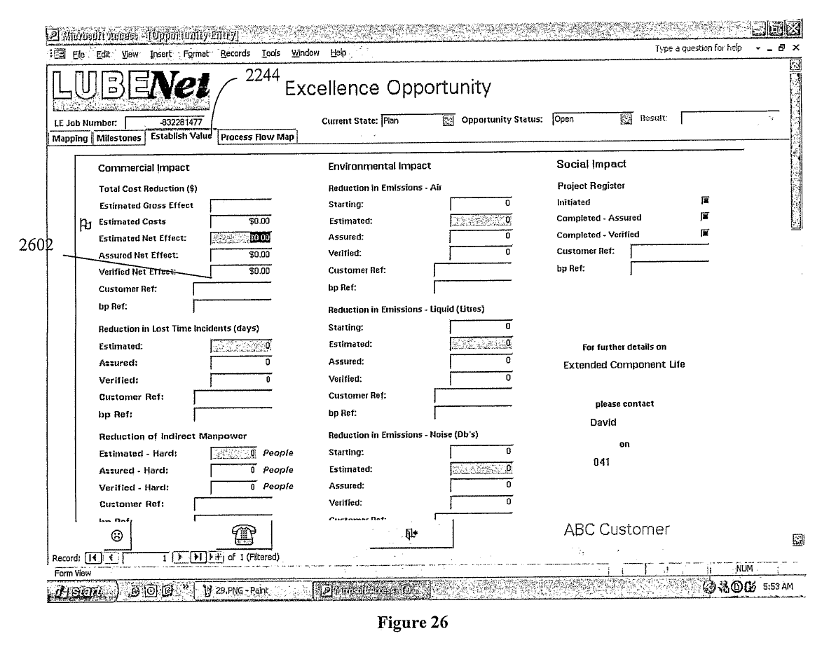

Returning to FIG. 23, an Establish Value button 2308 can be selected to establish the value of the opportunity to the customer at step 808 by entering values for each of the relevant KPIs, as shown in FIG. 26. (This screen can alternatively be accessed by selecting the Establish Value tab 2244.) The value of the opportunity is defined in terms of KPIs representing commercial values, environmental values, and social values. For each KPI, estimated, assured, and verified values are entered, together with references for the organisation and the customer. For example, in terms of commercial impact, the following fields are provided for the total cost reduction KPI:

(i) Estimated Value,
the estimated value is the first estimation of value evident during the planning phase of an opportunity to leverage value with the customer. The value recorded here is the organisation's best intention of potential value, allowing the customer and the organisation's team to openly challenge it.

(ii) Assured Value,
the assured value has had internal and external challenge applied to it around the organisation's ISO 9001:2000 audit protocols, and therefore this is the value that the organisation believes will be confidently accepted by the customer.

(iii) Verified Value,
the verified value is the value actually realised and acknowledged by the customer.

(iv) Customer Reference Point,
this indicates where the value is internally mapped within the customer, e.g., general ledger code, risk register number.

(v) The Organisation's Reference Point,
this indicates where the value is internally mapped within the organisation, e.g., general ledger code, risk register number.

As described above, the system stores and manages value to support the customer's triple bottom line, as follows:

Commercial Value:
(i) Total cost reduction;
(ii) Reduction in lost time incidents (Days);
(iii) Reduction in indirect manpower;
(iv) Increased plant availability ($); and
(v) Reduction in capital employed risk ($).

Environmental Value:
(i) Reduction in emissions—Air;
(ii) Reduction in emissions—Liquid (Litres);
(iii) Reduction in emissions—Noise (dB);
(iv) Reduction in emissions—Solids (Tonnes); and
(v) Project register.

Social Value:
This is used where an opportunity impacts an identified social risk of the customer's business, as described above.

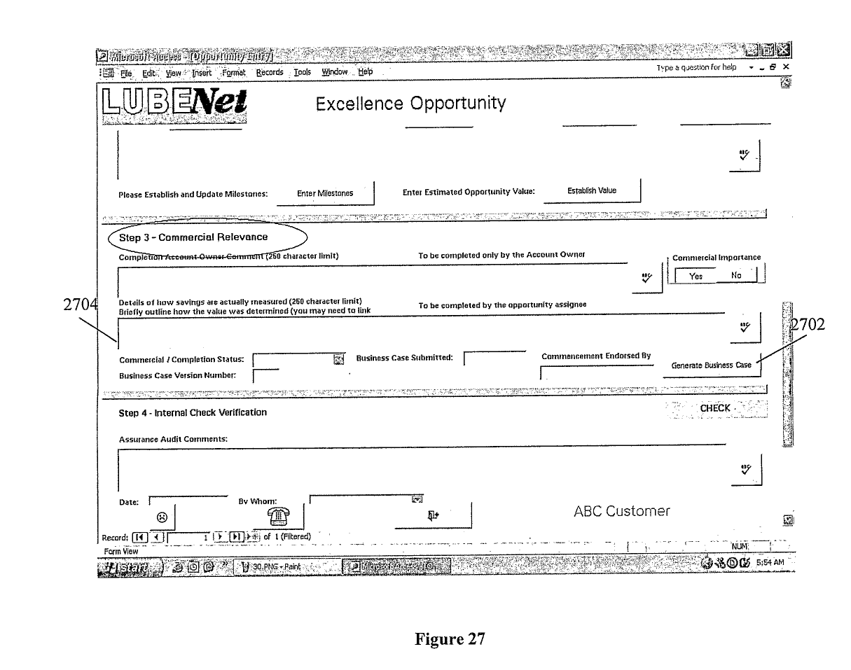

To complete major step 2 of the opportunity management process, the completion date is entered into a text box 2310, as shown in FIG. 23, and the opportunity can then progress to major step 3, Commercial Relevance, as follows. At step 810, the commercial relevance of the opportunity is indicated using a Completion/Commercial Relevance screen, as shown in FIG. 27. This screen is largely completed by the commercial negotiator of the customer's account and displays specific comments of the account negotiator relating to the commercial status of the opportunity for viewing by the opportunity owner. However, the “details of how savings are actually measured” text box 2704 is the responsibility of the opportunity owner, who enters brief details describing how the commercial, environmental and social values are determined.

The following controls are provided on this screen:
(i) Commercial Relevance: Comment relating to how the customer is to measure the value from the initiative. The cost saving formula.
(ii) Commercial Status: Set by the commercial negotiator.
(iii) Business Case Version: Current business case version being discussed with the customer. The business case is preferably discussed at various stages of the opportunity activity, and the system records when the last version was presented. The business case is a means to ensure that the organisation is on the right track with the customer.
(iv) Business Case Submitted: The date the business case was submitted to the customer.
(v) Completion Date: The date that step 2 was completed, including the completion of all relevant milestones.
(vi) Acknowledged By: the site contact who acknowledged the commencement of the initiative.

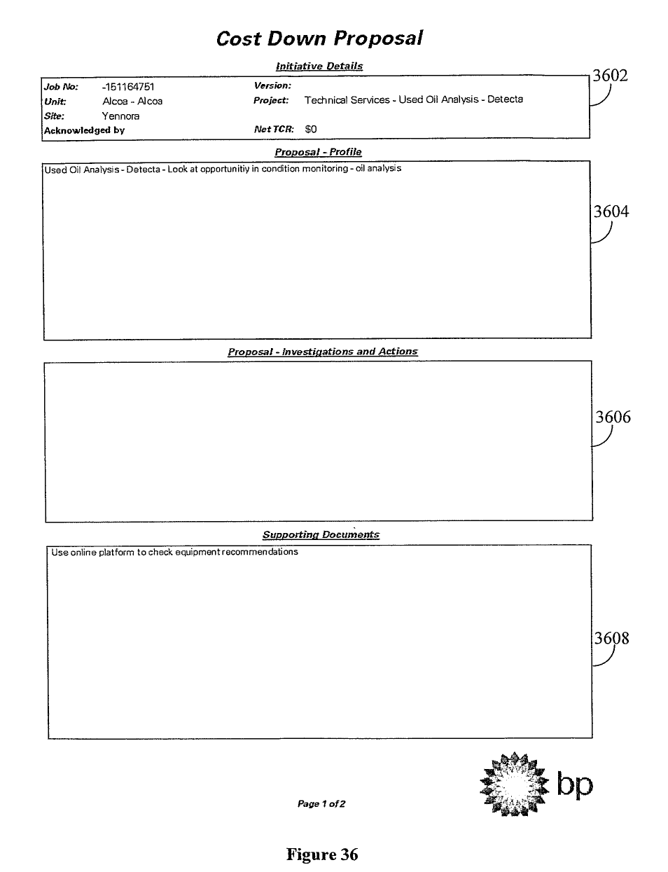

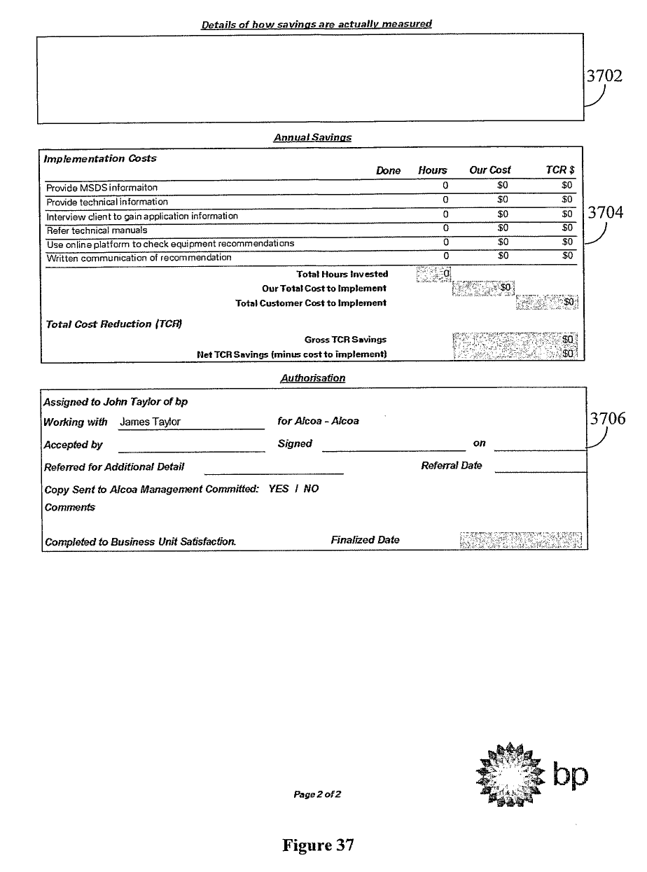

A Generate Business Case button 2702 can be selected to generate a business case directly from the system at step 812. The business case is a Microsoft Word document, as shown in FIGS. 36 and 37 that allows the opportunity to be actively worked with the customer. On completion of an opportunity, a specific business case is generated illustrating where the delivered value was recognised by the customer, with all supporting documentation, and justifying the net benefits to all stake holders.

The business case document is divided into the following sections:
(i) Initiative Details 3602;
(ii) Proposal-Profile 3604;
(iii) Proposal-Investigations and Actions 3606;
(iv) Supporting Documents 3608
(v) Details of how savings are actually measured 3702;
(vi) Annual Savings 3704; and
(vii) Authorisation 3706.

Each section of this document is populated by data entered into the value data system during one of the preceding steps. For example, the Initiative Details section 3602 is populated by the data entered at step 802, together with the Acknowledged By and Version fields entered by the contract negotiator at step 810. The Proposal-Profile section 3604 is also populated by the opportunity description text entered at step 802. The Investigations and Actions section 3606 is populated by the comments field at step 804, and the content of the Supporting Documents section 3608 is obtained from step 806. The Details of how savings are actually measured section 3702 is obtained from the comments field completed by the contract negotiator at step 810, the Annual savings information section 3704 is populated from the milestones established at step 806, and the value established at step 808. Finally, the Authorisation section 3706 is populated with data with the Working With the field from step 804, and the Accepted By and Finalised Date fields from step 816.

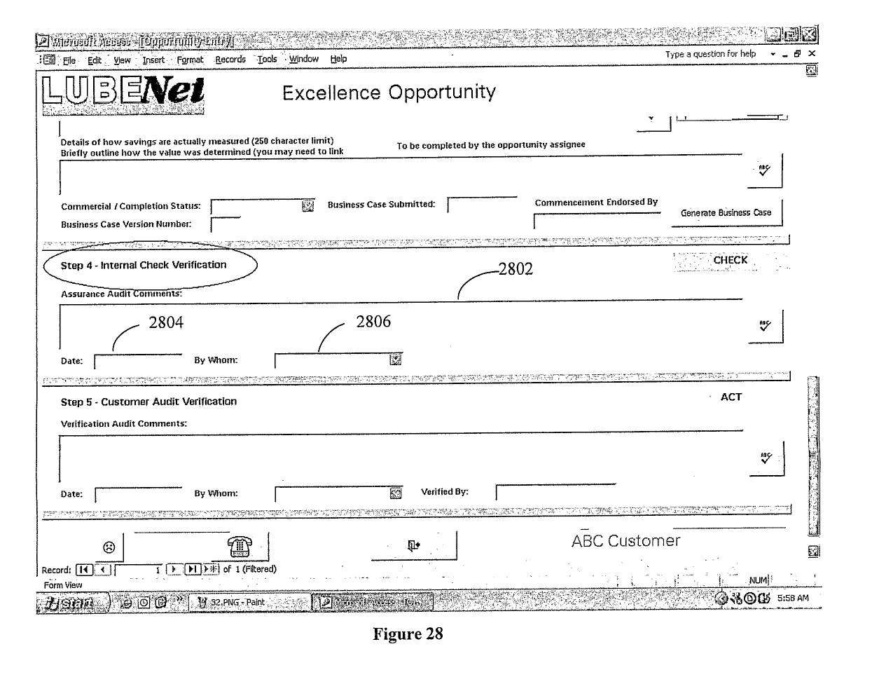

Once Major Step 2 (Commercial Relevance) is completed, the opportunity state can be moved from Do to Check using the current state menu 2223, initiating an internal audit step 814, as shown in FIG. 28. The internal audit step 814 ensures that the opportunity complies with ISO 9001:2000 audit protocols and the customer's commercial relevance and proposed outcome (as established at steps 802 to 810). Specifically, the internal audit verification screen provides an Assurance Audits Comments text box 2802, into which are entered any comments from the internal audit verification process. The date the internal audit was completed is entered into a date text box 2804, and the person conducting the internal audit (usually the Action assignee defined at step 802) is indicated by selecting their name from a By Whom pull-down menu 2806.

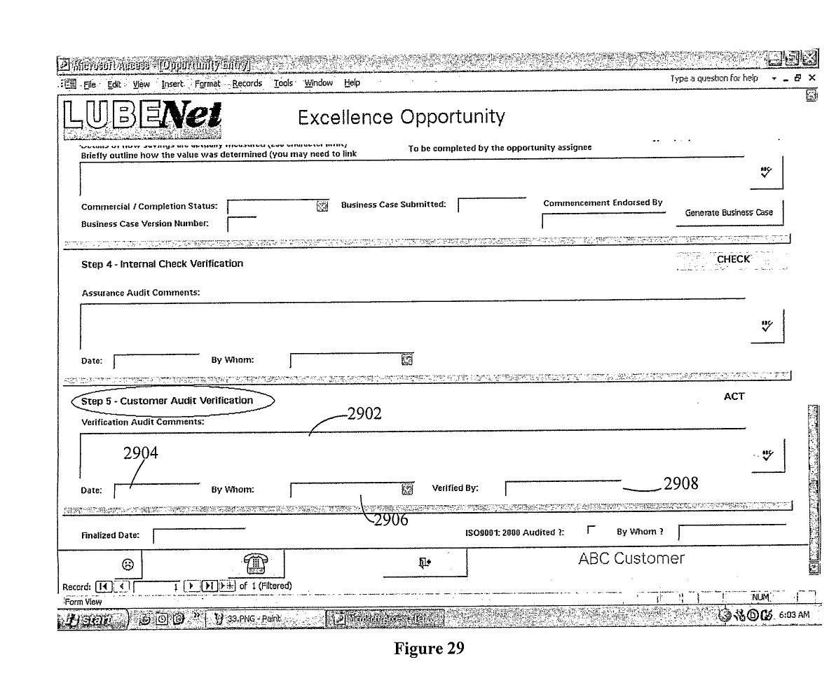

Once this is complete, the state of the opportunity is moved from Check to Act using the current state menu 2223, resulting in display of a Customer Audit Verification screen, as shown in FIG. 29, to initiate customer acknowledgment at step 816. This is the final step in obtaining customer verification, acknowledgment and sign off of the business case and allowing closure of the opportunity. Any customer comments and feedback are entered into a verification audit comment text box 2902, and the date the customer signed off on the business case is entered into a date text box 2904. The person commercially leveraging the business case proposal with the customer is indicated by selecting their name from a pull-down menu 2906, and the name of the customer's site contact who has accepted and verified the initiative is entered into a Verified By text box 2908.

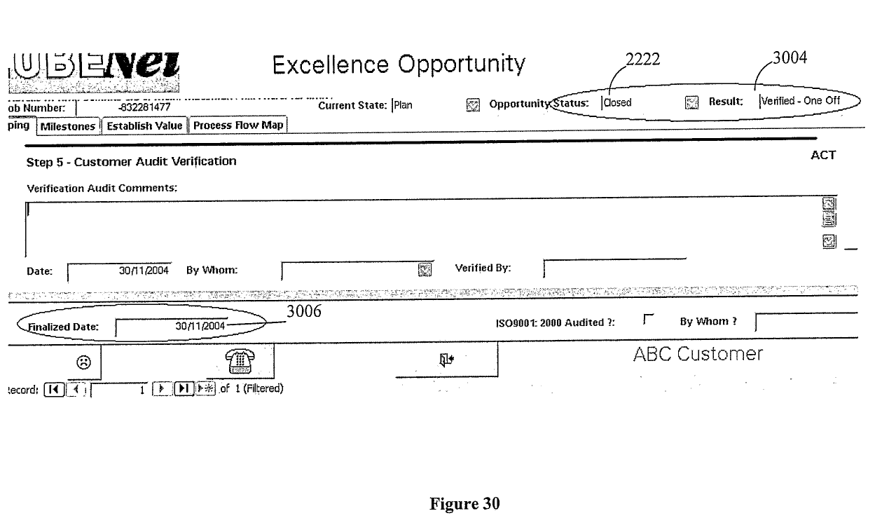

Once the business case has been submitted and the customer has returned a response, the opportunity is closed using the Opportunity Status menu 2222, and once closed, an opportunity result is selected from a result pull-down menu 3004, as shown in FIG. 30, being selected from the following values:
(i) LAPSED Could not be pursued or has been put on hold;
(ii) REJECTED INTERNAL Rejected internally by the organisation;
(iii) REJECTED CUSTOMER Rejected by the customer;
(iv) VERIFIED One-Off Acknowledged by the customer as a one off or annual saving; and
(v) VERIFIED Rolling savings Acknowledged by the customer and savings accepted during the term of the contract.

When closing an opportunity, the user should ensure that the following steps are completed:
(i) all fields in major steps 1 to 5 are completed;
(ii) the opportunity status has been changed to closed;
(iii) an opportunity result has been selected;
(iv) all milestones have been completed (100%);
(v) verified values have been recorded (Including Estimated and Verified values); and
(vi) the finalised date has been recorded.

The date the customer signed off on the business case is entered into a finalise date text box 3006, and the amount the customer accepted and signed off is entered into a Verified Net Effect box 2602, as shown in FIG. 26. This completes the opportunity management process 508.

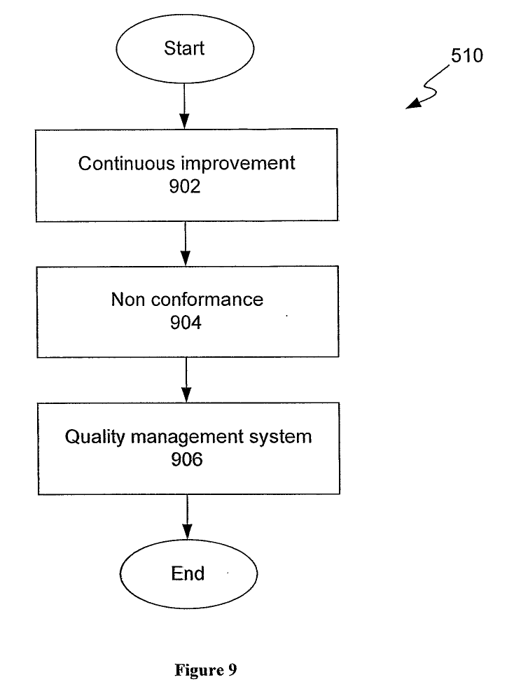

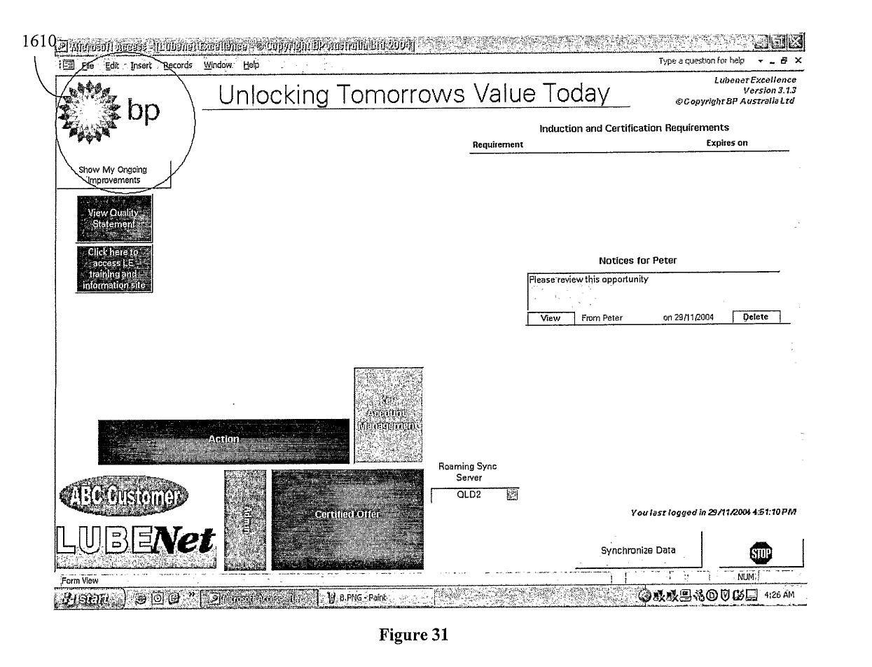

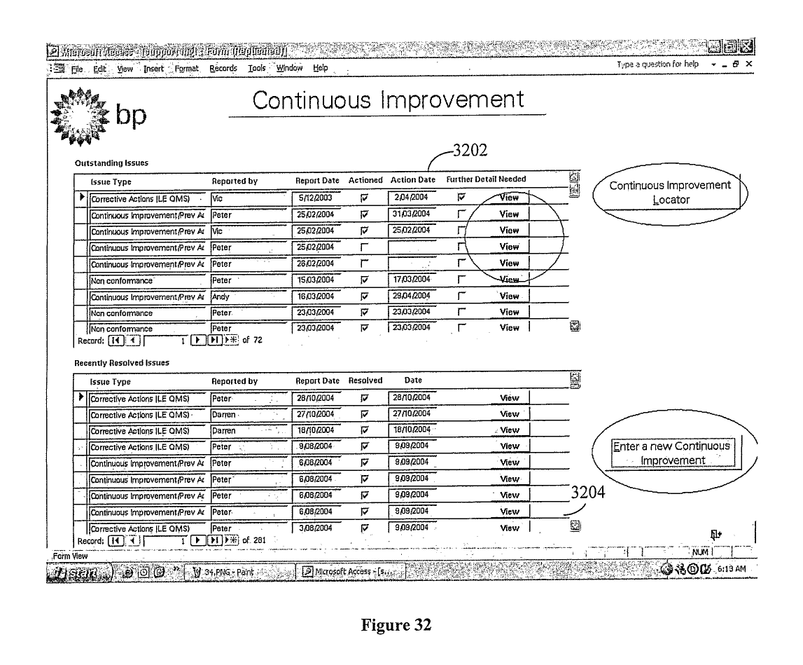

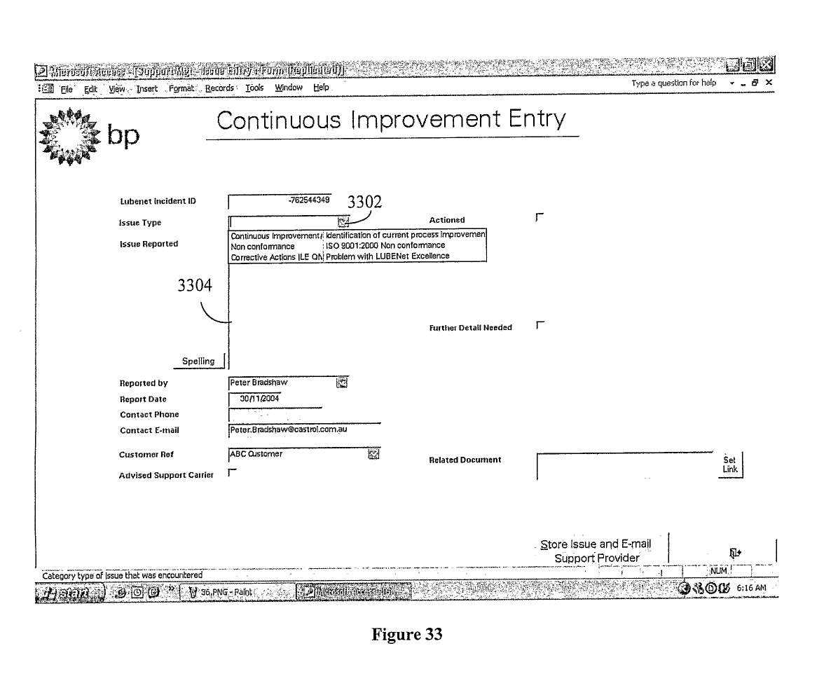

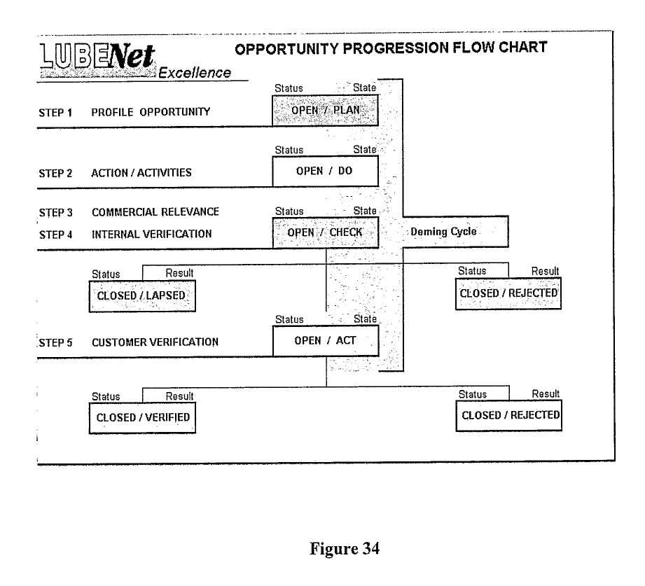

Returning to FIG. 5, in addition to creating and managing opportunities, the value data system manages continuous improvements, using a continuous improvement process 510, as shown in FIG. 9. The continuous improvement process features of the system can be accessed by selecting the organisation's logo 1610, as shown in FIG. 31, or a frowning face button 2236 of an opportunity, as shown in FIG. 22. This results in display of a continuous improvement screen, as shown in FIG. 32. The screen provides two scrollable tables, 3202, 3204 with an outstanding issues table 3202 listing outstanding (i.e., unresolved) issues, and a resolved issues table 3204 displaying resolved issues. For each issue, the tables 3202, 3204 list the issue type, the individual who reported the issue, the report date, a check box indicating whether the issue has been actioned, the action date, a check box indicating whether further detail is required, and a View button which, when selected, results in display of a continuous improvement entry screen, as shown in FIG. 33, allowing the user to enter details for the continuous improvement entry. Using an Issue Type pull down menu 3302, the user selects the type of the issue from three types of issues:
(i) continuous improvement;
(ii) non-conformance; and
(iii) system quality management.

A continuous improvement entry is a request to improve the value data process. A non-conformance entry identifies ISO 9001:2000 non-conformance, and a system quality management issue type relates to a fault or difficulty with the value data system and process. A textual description of the issue is entered into an issue details text box 3304.

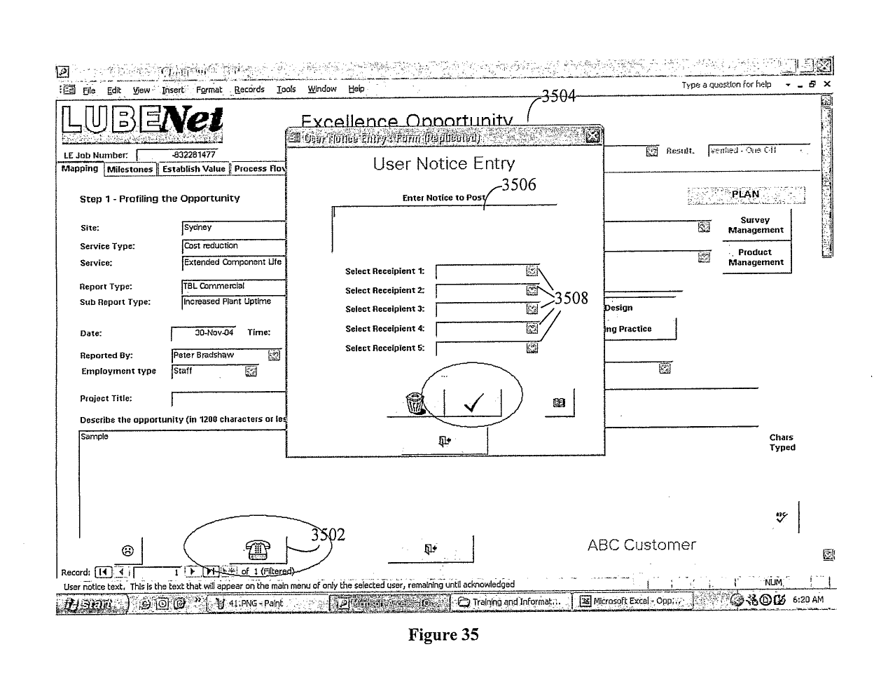

The value data system allows its users to communicate with each other via a notes messaging feature, as shown in FIG. 35. This feature is accessed by selecting a telephone icon 2238 in the opportunity screen. This results in the display of a User Notice Entry window 3504, as shown in FIG. 35, which provides a text box 3506 for entering the message text, and pull-down menus 3508 for selecting up to five recipients of the message. Such messages are actually delivered when the users synchronise their back end databases 204, as described above. When such a message is received by a recipient, it is displayed on the main screen of the value data system.

The value data system also provides the ability to generate and view various reports, as shown in the Table below, to progress monitoring and management of projects managed by the system. These reports also provide outcome evidence for contract reviews.

| Report Name | Report Description | Report Location |
|---|---|---|
| Print Opportunity | Contains specific details of | Action - Opportunity |
| | an opportunity | Locator Page |
| Service Management Plan | Management plan of the | Opportunity Locator |
| | service type. | page |
| Service Profile | Design team work | Service Design |
| | instructions | Management page |
| Audit Questionnaire | Audit Questionnaire | Service Design |
| | | Management page |
| Management Plan | Management Plan | Task Design page |
| HR Skill Matrix | Skills Matrix report | Skills Matrix page |
| Plant Survey x Ste | List of machines at a site | Survey Management |
| Where Products Is Used | List of products used at a site | Survey Management |
| Action Plans for Region | List of action plans defined | Team Leader Review |
| | for your region | |
| Customer Complaint | Customer Complaint | Lubenet Reporting |
| Summary | Summary Report | |
| Open Incident Report | Open Opportunity Summary | Lubenet Reporting |
| | Report | |
| Non Conformance Product | Non Conformance Product | Lubenet Reporting |
| Report | Report | |
| Actions Outstanding by | Actions Outstanding by | Lubenet Reporting |
| Assignee | Assignee | |
| Task List | Milestone workload by | Lubenet Reporting |
| | assignee | |
| Site Summary | Summary Report | Lubenet Reporting |
| Site TBL Summary | TBL Summary report by site | Lubenet Reporting |
| Service Catalogue | Service Catalogue | Lubenet Reporting |
| Approved Services Catalogue | Approved Services | Lubenet Reporting |
| | Catalogue | |
| Open Opportunity Status | Details of all open | Assignee Opportunity |
| Report-Assignee | opportunities by assignee | Status |
| Global Action Plans | Print Global Action Plans | Key Account TCR |
| | | Review |
| Customer Corporate KPI | Review performance to | Key Performance |
| Analysis | corporate KPIs | Indicators |
| Site - Asset KPI Analysis | Review performance to asset | Key Performance |
| | KPIs | Indicators |
| Corporate KPI Objectives | Corporate KPI Objectives | Corporate KPIs |
| Site KPI Objectives | Site KPI Objectives | Asset KPIs |
| HR Skills Matrix | Skills matrix management | Skills Matrix (Admin) |
| | report | |
| Lubenet Excellence | List all continuous | Ongoing Improvement |
| Continuous Improvements | improvements | locator |
| KAM Traffic Light Monthly | Key Account Monthly | Administrator |
| Report | Report | |
| LE Monthly Report | Lubenet Excellence monthly | Administrator |
| | statistics | |
| LE Customer Specific | Customer specific monthly | Administrator |
| Monthly/Quarterly Report | statistics and KPIs | |

The value data system and process described herein provide significant commercial advantages to the organisation, not only during performance of contracts with the organisation's customers, but also during contract negotiation. Currently, prospective vendors can only provide some general assurance that they will work with a prospective customer to meet their requirements in terms of delivering value during performance of an ensuing contract. However, the value data system and process allow an organisation to work together with the prospective customer during contract negotiations to develop objectives and KPIs for commercial, environmental, and/or social value, and the prospective customer can be assured of value delivery via the ISO 9001:2000 compliant value data process. As the customer is involved in this process, the customer can thereby be confident that value will be delivered and is therefore more likely to accept the organisation's offer over those of its competitors. This provides the organisation with a significant commercial advantage over its competitors.

Many modifications will be apparent to those skilled in the art without departing from the scope of the present invention as herein described with reference to the accompanying drawings.

APPENDIX 1
SERVICE TYPES

| Service Type | Service Type Description |
|---|---|
| Change Management | Managing change in clients |
| Oil Sampling Services | Use of oil analysis techniques to aid the value of the lubricant. |
| Technical Services | Technical Management services |
| HSSE | Environmental management service |
| Training | Sessions provided by the organisation's staff, providing structured |
| | material to assist the clients knowledge. |
| Cost reduction | Activities performed by the organisation's staff members that reduce |
| | the overall operation cost of our clients. |
| Key Account | Internal procedure to manage Key Accounts |
| Management | |
| Transformer | Services to aid transformer life |
| Management | |
| Unclassified | Service is yet to be classified |
| Customer Feedback | Management of customer feedback |
| Mgt | |
| Clean Oil | Provide client with clean oil stream to point of use |
| Lubrication | Unique lubrication technology that will increase customer |
| Technology | productivity |
| Engineering Services | Provision of Engineering expertise |
| Process | For designing procedures such as internal audits |
| ISO SOP | ISO standard operating Procedure |
| ISO Job Description | ISO Job Description |

APPENDIX 2
SERVICES

| Service | | |
|---|---|---|
| Type ID | Service | Service Description |
| Change | Fuels Implementation | Change management plan for new fuels supplier. Addressing potential |
| Management | Service | risk from product replacement, utilising, product application & |
| | | engineering knowledge. |
| Change | Lubricant Compartment | Identification of lubricant grades with unique colours to mitigate |
| Management | Colour Coding | the risk of incorrect product been filled in to machinery |
| | | compartments. |
| Change | Lubrication | Change management plan for new lubricant supplier. Addressing |
| Management | Implementation Plan | potential risk from product replacement, utilising, product |
| | | application &engineering knowledge. |
| Change | New Carrier Introduction | Conducting a Risk Assessment for new carrier introduction |
| Management | | |
| Change | On site Cleaners Audit | To establish understanding customers site cleaning requirements, to |
| Management | | allow a total cleaner solution to be offered |
| Clean Oil | BHP Billiton compartment | Implement a clean program to increase component life through |
| | clean oil program | reduction in lubrication compartment oil cleanliness. |
| Clean Oil | Clean Oil Delivery | To deliver clean oil to Customers Tanks |
| Clean Oil | Onsite clean oil audit | This audit is used to establish the contamination level of on-site |
| | | lubrication in storage and intermediate tankage prior to filling of |
| | | equipment comparments. The audit will provide constructive actions |
| | | that can be performed to improve oil cleanliness. |
| Clean Oil | Onsite clean oil | Provide clients a stream of lubricating oil that meets agreed ISO |
| | management program | cleanliness levels into fixed and mobile plant via primary & |
| | | secondary filtration and process controls. Clean oil streams provide |
| | | clients opportunity to reduce overall running costs of equip. |
| Clean Oil | On-site clean oil | Design storage &dispensing facility that maintains oil cleanliness |
| | storage design | of 13/16 ISO rating. Project manage the installation, commissioning |
| | | the process. |
| Cost | 2nd Tier Lubrication | 2nd Tier Service Management for sampling provided to the customer. |
| reduction | sampling Service | |
| | Management | |
| Cost | 2nd Tier lubrication | Set up a 2nd tier lubrication service contract |
| reduction | Service Contract set up | |
| Cost | 2nd Tier lubrication | 2nd Tier Tender checklist |
| reduction | Service Contract | |
| | tendering | |
| Cost | 2nd Tier Lubrication | Provision of a lubrication service via a subcontractor to meet an |
| reduction | Service Management | agreed schedule of maintenance. |
| Cost | Diversion of waste oil | |
| reduction | to ANFO | |
| Cost | Energy Reduction | Utilise known strategies to reduce energy consumption |
| reduction | Program | |
| Cost | Extended Component | To apply lubrication best practices or advanced lubricant formulation |
| reduction | Life | to increase the rebuild life of individual machine components |
| Cost | Extended lubrication | Utilise lubrication formulation that prolong the service interval, to |
| reduction | drain interval | increase Uptime, and decrease waste emissions |
| Cost | Financial Services | Provision of financial solutions |
| reduction | | |
| Cost | Fuel Risk Management | Reduce cost of Fuel through risk management on fuel pricing |
| reduction | Plan | |
| Cost | Gear Audit and | Conduct audit of gearbox gearing to establish potential areas of |
| reduction | Inspection | failure |
| Cost | Hydro Carbon | Hydrocarbon Management program has the organisation responsible for |
| reduction | Management | product management &deliver to point of use of hydrocarbons |
| Cost | Improved material | Review the overall site logistics movement of lubrication through |
| reduction | handling | improved material handling strategies. |
| Cost | LUBEnet Site Audit | Whilst conducting on-site field visits the following customer audit |
| reduction | | is conducted to highlight potential safety, logistical and |
| | | environmental innovations. |
| Cost | Lubrication Management | Lubrication Management System provides clients scheduled task |
| reduction | System (LMS) | management of lubrication and related maintenance activities. The |
| | | software enable clients to understand schedule compliance achieved |
| | | and can be managed in paperwork format or through hand held |
| Cost | Lubrication Survey | Verification of plant on site, lubricants in use and quantities and |
| reduction | (audit) | practices used to apply the lubes |
| Cost | Lubrication System | Provide on-site manpower to perform lube system audit to ensure |
| reduction | Inspections | system is dispensing correctly to OEM/owners specifications. |
| | | Typically the service is offered in Stationary Plant like Ball Mills |
| | | and Draglines, where large central systems are in operation |
| Cost | Mitigation of | Reduce the cost of money cost of money |
| reduction | transaction | |
| | cost of money | |
| Cost | On-site fluid | Utilising the technical engineers of the organisation to assess |
| reduction | dispensing program | customers method of dispensing fluid throughout a given site. A |
| | | complete report will result outlining effective methods to |
| | | efficiently dispense fluids. |
| Cost | Operational | Delivery of efficiencies relating to customer and the organisation |
| reduction | Efficiencies | operations |
| Cost | Performance Lube field | Dragline &shovel dragline field visit report, full lubrication |
| reduction | report draglines & | report on open gear and performance lube used in the plant. Any |
| | shovels | improvements are highlighted as well as Safety concerns. |
| Cost | Power Station Open Gear | Open gear lubrication program that reduces operational costs. Program |
| reduction | Lube Program | reduces environmental impact through integrated sampling &recycling |
| | | program. |
| Cost | Product Application | Provide on-site service manpower to apply, check lubrication of |
| reduction | | customers on-sie equipment |
| Cost | Product Rationalisation | Technically review the customers complete range of products, compare |
| reduction | | against the site wide range of OEM specifications to reduce the |
| | | number of duplicate products used without compromising equipment |
| | | warranty. |
| Cost | Reduce cost of product | Program to reduce transformational costs |
| reduction | logistics | |
| Cost | Service Management Fee | Service offered to customers based on a Chemical/Lubrication |
| reduction | | Management Service |
| Cost | Stock Management | Service to improve stock management |
| reduction | | |
| Cost | Trade with client | Trading through electronic interface with our client. Process can |
| reduction | via EDI | include management of RCTI generated by the customer. |
| Cost | Turbine oil additive | Simulate through laboratory testing of our customers turbine oil an |
| reduction | pack management | additive spike to bring the customers in-service turbine oil back |
| | | into specification limits. From the several controlled tests |
| | | formulate an additive spike for the station, monitor and re |
| Cost | Used oil to fuel | Implement WOTEC unit in the customer waste oil stream |
| reduction | program | |
| Customer Feedback | Contract Continuous | Improvement to the contract identified by the customer |
| Mgt | Improvement | |
| Customer Feedback | Contract Non | Non conformances against a customer contract |
| Mgt | Conformance [against | |
| | customer] | |
| Customer Feedback | Contract/Customer | Direct feedback from the Customer in reference to how the |
| Mgt | Feedback | organisation are managing the contract and/or account. |
| Customer Feedback | Feedback Mgt - Internal | Handling and resolution of customer complaints received for internal |
| Mgt | Administration | administration errors or issue such as Invoicing, Order entry, |
| | | Planning, Sales. This relates to the product certification |
| Customer Feedback | Feedback Mgt - Internal | Handling and resolution of customer complaints received for internal |
| Mgt | Logistics | logistic related errors or issues such as Delivery, Dispatch, |
| | | Delivery, Manufacturing and Storage. This relates to the product |
| | | certification |
| Customer Feedback | Feedback - Quality of | Product quality management. This relates to the product certification |
| Mgt | Product | |
| Customer Feedback | Lubenet Excellence | How you recover field base users and the main database if you |
| Mgt | Data Recovery Plan | experience problems with data integrity |
| Customer Feedback | Profitability Defects | Pickup of internal system defects that affect the organisation's |
| Mgt | (Internal Use Only) | Profitability. |
| Engineering | Dangerous Goods | WA Specific: Provide consultancy to obtain Dangerous Goods Storage |
| Services | Licensing WA Specific | License |
| Engineering | Facility compliance | Structured audit to ensure the facility is compliant to Australian & |
| Services | check | regularity standards, and if not identify non compliance, and provide |
| | | recommendations for compliance. In addition efficiency |
| | | recommendations will be made where applicable. |
| Engineering | Facility Design & | Design &Construction of Hydrocarbon Storage Facility |
| Services | Construction | |
| Engineering | Facility Design &Cost | Design compliant hydrocarbon storage facility |
| Services | | |
| Engineering | Implementation Plan | Manage implementation of new bulk fuel and lube customers. |
| Services | for New Customer | |
| Engineering | Manuals and Material | Training material, auditing and procedure manual for the safe |
| Services | for safe handling | handling and storage of lubricants and other substances. |
| | &storage | |
| Engineering | Procurement of | |
| Services | Equipment | |
| Engineering | Project Management | |
| Services | | |
| Engineering | Service Management | Provide Scopes of works, drawings, work plans etc for tender |
| Services | Documentation | documentation or services on customer's sites |
| HSSE | Biodiversity | Individual site audits on biodiversity risks and solutions. |
| | Conservation | Cost Down Implementation program also available on request. |
| HSSE | Bund exception | Bund exemption from environmental agency/mines departments |
| HSSE | Contractor | Auditing and Compliance Program to assist in meeting and ensuring |
| | Accreditation | standard through targeted channel. |
| | Program | |
| HSSE | Emergency Response | Training forum package includes theory session, &practical test of |
| | Forum | current site emergency response. |
| HSSE | Ethics - Corporate | Current assessment on real and potential risks to business. Methods |
| | Governance in Practice | and tools to take the business model to desired level. |
| HSSE | Front Line Team Mining | To identify &execute opportunities to mining sector |
| HSSE | Global Choice | Global choice is an environmental fund allowing the organisation's |
| | | customers to cancel out the green house gases caused by their cars, |
| | | trucks or diesel generators. |
| HSSE | Green Office Program | The Green Office program is an office-based program designed by staff |
| | | who wish to play an integral role in reducing the impact of their |
| | | work practices and buildings on the environment. In particular to, |
| | | reduce paper consumption, reduce energy consumption, |
| HSSE | Green Procurement | Management Tool in procurement of environmentally sound products and |
| | Grid | services to reduce unwanted emissions. |
| HSSE | Handling &Freight | Procedure Manual that integrates current OHS legislation for small to |
| | Manual | medium sized businesses. |
| HSSE | HSE Rewards | HSE Rewards is a program that can be offered through the customers |
| | | site, recognises efforts after a given period of the workers, one |
| | | winner is recognised with some form of corporate merchandise. |
| HSSE | Incident Tracking | Software provided to clients through online incident tracking system. |
| | TRACTION | Spills near miss's and safety incidents. System reduces the |
| | | likelihood of repeating incidents. Aggregated incidents allows |
| | | continuous improvement process. Traction uses two type of in |
| HSSE | Injury Management | |
| | Training | |
| HSSE | Product MSDS | Provide MSDS information to support our brand policies |
| | Information | |
| HSSE | Safety and Health | Program on engaging stakeholders in Safety and Health Business |
| | Leadership | Practices. |
| HSSE | Spill reduction | Our standard spill bin comes complete with a rugged carrying satchel, |
| | program | instructions and disposal bags with colour-coded content sufficient |
| | | to deal effectively with a spill up to 60 litres. In addition, our |
| | | “universal” spill kits offer effective control of |
| HSSE | Sulphur Emission | Supply of Ultra Low Sulphur fuel (50 ppm), will directly reduce |
| | reduction program | sulphur emissions. The Sulphur Emission reduction program provides |
| | | auditable data to illustrate impact on sulphur airborne emissions. |
| | | The quarterly report can then link as a ISO 14001 miti |
| HSSE | Water Conservation | Individual site audits to assess current usage, current supply, |
| | | current discharge. Cost Down Implementation program also available |
| | | on request. |
| ISO Job | Customer Value | Customer Value Facilitator job description. Is the nominated |
| Description | Facilitator | management represented person for the quality system. Objectives are |
| | | based on mitigating assessed risk. |
| ISO SOP | Control of Records | This procedure is designed to establish, control and maintain records |
| | | that provide evidence of the effective operation of the value data |
| | | system |
| ISO SOP | Corrective Action | This procedure defines the actions taken to eliminate the cause of |
| | | nonconformities in order to prevent recurrence. Corrective Actions |
| | | shall be appropriate to the effects of the nonconformities |
| | | encountered. |
| ISO SOP | Design Planning | This procedure, SOP-666331452, describes how the organisation plans |
| | | and controls the design and development of its Service Offers. It is |
| | | called from WI-L004, the Service Design procedure. |
| ISO SOP | Document Control | Instruction for the control of documents |
| ISO SOP | Internal Audit | This schedule defines our planned audit program, which has been |
| | Planning | developed after considering the status and importance of the |
| | | processes and areas to be audited, as well as the results of previous |
| | | audits. This schedule is called from our Internal Auditing |
| ISO SOP | Internal Auditing | Procedure for Auditing of LEX itself and of the services provided |
| | | under its scope. Service type should be “LEX Documentation” |
| ISO SOP | Non-conforming | This procedure ensures that Service Designs and Opportunities that do |
| | Services | not conform to requirements are identified and controlled to prevent |
| | | unintended use or delivery. |
| ISO SOP | Preventative Action | This procedure defines the actions taken to eliminate the cause of |
| | | potential nonconformities in order to prevent their occurrence. |
| | | Preventative Actions shall be appropriate to the anticipated effects |
| | | of the potential problems. |
| ISO SOP | Quality Manual | The value data system covers the organisation's Offer including all |
| | | contracted services and post delivery activities at selected customer |
| | | sites: Those activities that require more than simple supply of a |
| | | product at a price. |
| ISO SOP | Training | To analyses the needs and design, deliver and evaluate the |
| | | appropriate training program. |
| Key Account | ISO Contracts & | To review tenders, and contracts containing special requirements, to |
| Management | Tender Review | ensure that customer requirements are adequately defined and recorded |
| | | and that ambiguities are resolved. And that we have the capability to |
| | | meet contract and order requirements and that |
| Key Account | Key Account | Account management process, profiling risks and mitigation strategy |
| Management | Management | to manage client to agreed contract. |
| Key Account | Lubricant Supply | Identify all risks associated with the suppiy of contracted |
| Management | Chain Risk | lubricants &cleaners. The assessment generates a complete mitigation |
| | Assessment | plan with audit questionnaire. All mitigations link directly to ISO |
| | | 9001 compliant policies &Work instructions. |
| Key Account | On-Track Management | Management Plan to administer national sales management tool to |
| Management | Plan | support WCCM |
| Lubrication | Lubrication | Provide an extreme pressure general purpose mine grease. Product |
| Technology | Technology - | specifically designed for dragline line and open cut mining |
| | BP Mine Grease | operations. |
| Lubrication | Lubrication | To provide a diesel engine oil to either extend the drain interval |
| Technology | Technology - | and or the component life or both. |
| | Enduron S | |
| Lubrication | Lubrication | Lubrication Technology that will increase extended drains in final |
| Technology | Technology - H.S.A. | drive gear oils in mining applications |
| | Final Drive G/oil | |
| Lubrication | Lubrication | |
| Technology | Technology - | |
| | Hyspin AWH Hyd | |
| Lubrication | Lubrication | Use of lubrication technology to innovate general lubrication |
| Technology | Technology - | products |
| | Product replacement | |
| Lubrication | Lubrication | Reformulation of RX Super to out perform the API CI specification. |
| Technology | Technology - | |
| | RX Super CI | |
| Lubrication | Lubrication | |
| Technology | Technology - | |
| | SBX2 Grease | |
| Lubrication | Product Quality | |
| Technology | Testing | |
| Lubrication | Product Replacement | Management of product trials to verify improved process performance |
| Technology | | through alternative lubricant recommendation |
| Lubrication | Technology Plan | A customer specific plan targeting lubrication technology to |
| Technology | | innovate the customer specific business drivers and or problems. |
| Lubrication | Voith Fluid Coupling | Use oil technology approved to Voith specification to achieve |
| Technology | Energy Optimisation | maximum efficiency from coupling |
| Oil Sampling | AAS Commissioning | Safe installation and work permit requirements for installation of |
| Services | | Atomic Absorption Spectrometer |
| Oil Sampling | Lubricant condition | LUBEnet strategically target traditional wear metal analysis |
| Services | monitoring program | techniques, to identify opportunities for greater plant uptime. |
| | | Results are uploaded onto a internet platform for easy access. |
| Process | Contract value | Contract auditing process to ensure contract additional value is |
| | management to ISO | managed to ISO 9001:2000. As a result of audit contract will either |
| | 9001:2000 | be certified or not certified compliant. This service is excellent |
| | | as a starting point prior to starting the contract. |
| Process | ISO 9001:2000 | Auditing to ISO 9001:2000 the value data process. The system manages |
| | compliance | contract performance KPIs, account activity registers, and risk |
| | | management process for all additional contract activities. |
| Process | LUBENet Excellence | The value data system bi annual service review |
| | QMS | |
| Process | Service Management | Process to continuously improve development of services |
| | (New/Existing) | |
| Process | Service recall | Process to recall and manage service offer should review of current |
| | | risk assessment highlight business exposure. |
| Technical | Help Line Technical | Technical support provided to customer in the cause of normal supply |
| Services | Support | |
| Technical | Product Technical | Product &Technical data sheet request, Equivalents, Lube Guide/ |
| Services | Advice | Plant Survey support. |
| Technical | R &D | Where current product performance does not meet customer's business |
| Services | | requirements, local laboratories can be utilised to perform research |
| | | &development to target specific lubrication characteristics to |
| | | rectify the current performance issues. Our Australian |
| Training | Advanced Safety | Advanced Safety Auditing provides clients feedback on potential |
| | Auditing | safety hazards that can be identified and communicated back to the |
| | | client to eliminate a hazard. |
| Training | ASA Training | Training programs that embed risk analysis and knowledge sharing |
| | | within dynamic environments. |
| Training | Clean Oil Training | |
| | Program | |
| Training | Direct Customer | Training provided directly to clients staff to achieve a desired |
| | Training | business outcome to improve their business. |
| Training | Generic Training | |
| | Requirement | |
| Training | Manual Handling | Workshop training that enforces best practice in health of employees, |
| | Training | storage of product, and assist in minimising incidents (spill, |
| | | health etc) |
| Training | Media Training | Comprehensive course that assists in how media works and handling |
| | | media in times of crisis. |
| Training | Road Safety Program | Light and Heavy Vehicle driver programs. Group training sessions |
| | | and comprehensive promotional campaign. |
| Training | Root Cause Analysis | Incident Investigation Training. Provides tools to establish means |
| | | and causes of actual and potential (near miss) incidents |
| Transformer | Transformer oil De | Chemical process that destroys PCB levels in transformer oil |
| Management | chlorination | |
| Transformer | Transformer Oil | Where transformer oil is in service with high acidity, moisture, |
| Management | Regeneration | IFT readings, mobile transformer oil regeneration can be performed |
| | | on the oil whilst still in service. Regeneration can be performed |
| | | whilst the transformer is on line or off line. |
| Transformer | Transformer oil | Manage of storage filtering and regeneration of transformer oil. |
| Management | terminal management | Receipt &disposal of transformer bodies. |
| Transformer | Transformer risk | Results from previous and current transformer sampling are |
| Management | assessment | interpreted by TRANSCARE TRP process. Customers are provided a |
| | | holistic risk assessment of their transformers, relating risk to |
| | | production. |
| Transformer | Transformer Sampling | Transformer sampling performed by industry trained personnel, |
| Management | Program | transformer oil samples are processed in NATA certified laboratories, |
| | | results generated from this testing program are challenged with over |
| | | 30 electrical techniques to provide a holistic assessment |
| Unclassified | BHP Billiton FLAC | BHP Billiton uses this evaluation to review Fuel, Lubrication, Air & |
| | Evaluation | Coolants use at the asset to identify opportunities for improvement |
| Unclassified | Community Relations | Any program that supports the local communities |
| | Program | |
| Unclassified | Unclassified | Service is not currently contained in the services listing and is |
| | | therefore unclassified. |

1. A value data system, including:
a database component, including:
initiative data representing at least one initiative, said at least one initiative being adapted to deliver value to a customer of an organisation;
risk data associated with said initiative data, said risk data representing risks corresponding to said at least one initiative;
task data associated with said initiative data, said task data representing tasks to be performed to perform said at least one initiative, said tasks including risk mitigation tasks for mitigating said risks; and
value data associated with said initiative data, said value data representing values delivered to said customer as a result of performing said at least one initiative;
and
a user interface component for:
(i) defining said initiative data, said risk data, said task data, said value data and the associations between said initiative data, said risk data, said task data, and said value component data; and
(ii) defining value data representing values delivered to said customer as a result of performing said at least one initiative.

2. A value data system as claimed in claim 1, including a document generator for generating at least one document including at least part of said initiative data for said at least one initiative and at least part of said value data representing value delivered to said customer as a result of performing said at least one initiative.

3. A value data system as claimed in claim 2, wherein said at least one document includes a business case document for sign off by said customer to acknowledge the delivery of said value to said customer.

4. A value data system as claimed in any one of claims 1 to 3, wherein said activity data includes status data representing a status of each of said at least one initiative.

5. A value data system as claimed in any one of claims 1 to 4, wherein said activity data includes progress data representing progress towards the completion of each of said tasks.

6. A value data system as claimed in any one of claims 1 to 5, wherein said database component includes responsible entity data associated with said task data, said responsible entity data representing entities responsible for performance of said tasks.

7. A value data system as claimed in any one of claims 1 to 6, wherein said database component includes skill data associated with said task data, said skill data representing skills required to perform said tasks.

8. A value data system as claimed in any one of claims 1 to 7, wherein said value data includes estimated value data, said estimated value data being an initial estimate of value to be delivered to said customer as a result of performing said at least one initiative.

9. A value data system as claimed in any one of claims 1 to 8, wherein said value data includes assured value data, said assured value data being an audited estimate of value to be delivered to said customer as a result of performing said at least one initiative.

10. A value data system as claimed in any one of claims 1 to 9, wherein said value data includes verified value data, said verified value data being value actually delivered to said customer as a result of performing said at least one initiative.

11. A value data system as claimed in any one of claims 1 to 10, wherein said initiative data includes initiative owner data identifying at least one entity responsible for managing the performance of said at least one initiative.

12. A value data system as claimed in any one of claims 1 to 11, wherein said database component includes cost data associated with said task data, said cost data representing costs incurred to perform said tasks.

13. A value data system as claimed in any one of claims 1 to 12, wherein said initiative data includes value measurement data representing how said value is to be determined.

14. A value data system as claimed in any one of claims 1 to 13, wherein said value data represents a plurality of types of value.

15. A value data system as claimed in claim 14, wherein said plurality of types of value includes at least one type of commercial value, at least one type of environmental value, and at least one type of social value.

16. A value data system as claimed in claim 15, wherein said at least one type of commercial value includes at least one of total cost reduction, reduction in lost time incidents (LTI), reduction of indirect manpower, increased plant availability, and reduction in capital employed risk.

17. A value data system as claimed in claim 15 or 16, wherein said at least one type of environmental value includes at least one of: reduction in air emissions, reduction in liquid emissions, reduction in noise emissions, reduction in solid emissions, and an entry of an environmental risk register of the customer.

18. A value data system as claimed in any one of claims 15 to 17, wherein said value data includes value reference data associating each of said types of value with a corresponding ledger code or risk register entry.

19. A value data system as claimed in any one of claims 1 to 18, wherein said initiative data includes value component data representing selected types of said values affected by said at least one initiative.

20. A value data system as claimed in any one of claims 1 to 19, wherein said initiative data includes infrastructure data representing customer infrastructure in relation to which said at least one initiative is to be performed.

21. A value data system as claimed in any one of claims 1 to 20, wherein said initiative data includes product data representing products of said organisation in relation to which said at least one initiative is to be performed.

22. A value data system as claimed in any one of claims 1 to 21, wherein said user interface component is adapted to select at least part of said initiative data from generic initiative data representing a plurality of generic activities for delivering value, the system being adapted to determine said risk data, said task data, and said value data on the basis of said associations.

23. A value data system as claimed in any one of claims 1 to 22, wherein said initiative data includes initiative state data representing a state of said at least one initiative as one of plan, do, check, and act states.

24. A value data system as claimed in any one of claims 1 to 23, wherein said initiative data includes initiative status data representing a status of said at least one initiative as being active or inactive.

25. A value data system as claimed in any one of claims 1 to 24, wherein said risk data includes risk priority data for each risk, said risk priority data including a risk priority number for each risk and a mitigated risk priority number generated by the system on the basis of the risk priority data for the risk and a corresponding reduction in said risk priority data as a result of performing one or more risk mitigation tasks for mitigating the risk.

26. A value data system adapted to maintain initiative data representing initiatives for delivering value to a customer of an organisation, said initiative data including state data representing a state of each initiative and value data representing value delivered to said organisation as a result of performing said initiatives.

27. A value data system as claimed in claim 26, wherein said initiative data includes milestone data representing activities to be performed to perform each initiative.

28. A value data system as claimed in claim 26 or 27, wherein said value data includes KPI data representing components of said value.

29. A value data system as claimed in any one of claims 26 to 28, wherein said value includes commercial value, environmental value, and social value.

30. A value data system as claimed in any one of claims 26 to 29, wherein the system includes a user interface component for generating new initiatives on the basis of predetermined initiative data.

31. A value data process executed by a computer system, including maintaining initiative data representing initiatives for delivering value to a customer of an organisation, said initiative data including state data representing a state of each initiative, and value data representing said value as one or more key performance indicators.

32. A value data process as claimed in claim 31, including receiving KPI data defining one or more of said key performance indicators.

33. A value data process as claimed in any one of claims 31 to 32, wherein said initiative data includes a textual description of said initiative.

34. A value data process as claimed in any one of claims 31 to 33, wherein said initiative data includes milestone data representing activities to be performed to realise each initiative.

35. A value data process as claimed in any one of claims 31 to 34, wherein said milestone data includes milestone progress data representing progress of each milestone.

36. A value data process as claimed in any one of claims 31 to 35, wherein said initiative data includes assignee data representing an individual assigned to manage performance of said initiative.

37. A value data process as claimed in any one of claims 31 to 36, wherein said initiative data includes priority data representing a priority of said initiative.

38. A value data process as claimed in any one of claims 31 to 37, including selecting said initiative data as a subset of second initiative data for delivering value to customers of said organisation.

39. A value data process as claimed in any one of claims 31 to 38, wherein said initiative data includes site data representing a selected work site of said customer for performance of said initiative.

40. A value data process as claimed in any one of claims 31 to 39, wherein the process includes generating a new initiative on the basis of one or more predetermined milestones.

41. A value data process as claimed in any one of claims 31 to 40, including maintaining customer data relating to one or more customers of said organisation, said customer data including site data for one or more sites of said one or more customers.

42. A value data process as claimed in any one of claims 31 to 41, wherein the initiative data representing an initiative includes customer identification data identifying a corresponding customer, organisation owner data identifying an employee of said organisation responsible for managing said initiative, and customer owner data identifying an employee of said customer responsible for managing said initiative.

43. A value data process as claimed in any one of claims 31 to 42, including maintaining service data representing generic initiatives for delivering value to customers of said organisation.

44. A value data process as claimed in any one of claims 31 to 43, wherein said service data also represents customer-specific activities for delivering said value.

45. A value data process as claimed in any one of claims 31 to 44, including generating a business case document for signoff by said customer to acknowledge delivery of said value.

46. A value data process as claimed in claim 45, wherein the business case document includes one or more portions for said customer to describe how the acknowledged value was delivered to said customer.

47. A value data process as claimed in any one of claims 31 to 46, wherein said value includes one or more of commercial value, environmental value, and social value.

48. A value data process as claimed in any one of claims 31 to 47, wherein the state of each initiative is represented as one of plan, do, check, and act.

49. A value data process as claimed in any one of claims 31 to 48, wherein said initiative data includes status data representing a status of each initiative as one of open and closed.

50. A value data process as claimed in any one of claims 31 to 48, wherein said activities provide risk management certified to AS4360.

51. A value data process as claimed in any one of claims 31 to 50, wherein the process is compliant to ISO9001:2000.

52. A value data process as claimed in any one of claims 31 to 51, wherein the process is compliant to ISO9001:2000 and includes receiving customer feedback for auditing the process, and improving the process on the basis of said auditing.

53. A value data process as claimed in any one of claims 31 to 52, wherein the process is compliant to ISO9001:2000 and uses continuous improvement to drive best practice.

54. A value data system having components for executing the steps of any one of claims 31 to 53.

55. A computer readable storage medium having stored thereon program instructions for executing the steps of any one of claims 31 to 53.
